(19) United States
(12) Patent Application Publication
(10) Pub. No.: US 2026/0290374 A1
(43) Pub. Date: Sep. 24, 2026

(54) SYSTEM

(71) Applicant: SoftBank Group Corp., Tokyo (JP)

(72) Inventor: Seitaro MURA, Tokyo (JP)

(73) Assignee: SoftBank Group Corp., Tokyo (JP)

(21) Appl. No.: 19/558,542

(22) Filed: Mar. 6, 2026

(30) Foreign Application Priority Data
Mar. 19, 2025 (JP) 2025-044539

(51) Int. Cl. G10L 25/63; G10L 15/02; G10L 15/04; G10L 15/16

(52) U.S. Cl. CPC G10L 25/63; G10L 15/02; G10L 15/04; G10L 15/16; G10L 2015/025

(57) ABSTRACT

A system includes a processor that is configured to switch a received communication from a human response to an artificial intelligence automatic response, acquire voice data associated with the received communication and convert the voice data into text data by using a speech recognition technique, and analyze the text data by using a natural language processing technique and generate a prompt for determining a falsehood level of a statement contained in the text data.

### CROSS-REFERENCE TO RELATED APPLICATION

This application is based on and claims priority under 35 USC 119 from Japanese Patent Application No. 2025-044539 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional telephone and communication systems rely primarily on human judgment to assess the credibility of a caller's statements and to decide how to respond. In many situations, such as fraudulent calls, harassment, or calls involving potential perjury or deception, the user is required to make rapid decisions under psychological pressure, without sufficient tools to objectively evaluate the truthfulness of the caller's statements. Furthermore, existing systems generally do not provide a mechanism for seamlessly switching from human handling of a call to an artificial intelligence automatic response, nor do they provide integrated functions for acquiring voice data, converting the voice data into text, and analyzing the text to assess a falsehood level of the caller's statements. As a result, users are exposed to an increased risk of being misled or coerced into undesirable actions, and they lack structured guidance on what next actions should be taken. Additionally, known systems do not adequately take into account the emotional state of the user when presenting recommended actions, which can lead to suggestions that are either excessively aggressive, insufficiently protective, or otherwise misaligned with the user's psychological condition. Therefore, there is a need for a system that can automatically take over communication from a human to an artificial intelligence automatic response, objectively analyze the content of the communication to determine a falsehood level, generate prompts for appropriate next actions, and further adjust such proposed actions based on an analysis of the user's emotional state.

### SUMMARY

In order to solve the above-described problems, an embodiment of the present invention provides a system comprising a processor, wherein the processor is configured to switch a received communication from a human response to an artificial intelligence automatic response. The processor is further configured to acquire voice data associated with the received communication and convert the voice data into text data by using a speech recognition technique. The processor is also configured to analyze the text data by using a natural language processing technique and generate a prompt for determining a falsehood level of a statement contained in the text data. According to another aspect, the processor is configured to generate, based on a result of the determination of the falsehood level, a prompt for proposing a next action to be taken, such as contacting law enforcement authorities, blocking the caller, requesting additional verification, or terminating the communication. Furthermore, in a further aspect, the processor is configured to analyze an emotional state of a user by using an emotion analysis engine and generate, based on a result of the analysis, a prompt for adjusting an action proposed to the user. By switching communication handling to artificial intelligence, automatically converting speech to text, performing natural language analysis to determine a falsehood level, and tailoring proposed actions according to both the falsehood determination and the user's emotional state, the system can support the user in making more objective, timely, and psychologically appropriate decisions in response to potentially deceptive or harmful communications.

The term “processor” refers to one or more hardware processing units, such as a central processing unit (CPU), a microprocessor, a digital signal processor (DSP), or any combination thereof, that executes instructions to perform the functions described in the present specification.

The term “system” refers to an arrangement including at least the processor and any associated memory, communication interfaces, storage devices, and software components that cooperate to implement the functionalities described in the claims.

The term “received communication” refers to any incoming communication session, including but not limited to a voice call, video call, or other audio-based or multimedia communication, that is directed to a user and is processed by the system.

The term “human response” refers to a mode of handling the received communication in which a human user directly participates in the communication by speaking, listening, or otherwise interacting with the other party.

The term “artificial intelligence automatic response” refers to a mode of handling the received communication in which one or more artificial intelligence algorithms automatically generate responses, without requiring real-time human intervention, to interact with the other party.

The term “voice data” refers to audio data obtained from the received communication, including the speech of at least one of the parties to the communication, which is suitable for processing by a speech recognition technique.

The term “speech recognition technique” refers to any algorithm, model, or software capable of converting voice data into text data, including but not limited to automatic speech recognition (ASR) systems based on statistical models, neural networks, or hybrid approaches.

The term “text data” refers to a machine-readable representation in character or token form of content derived from the voice data by the speech recognition technique.

The term “natural language processing technique” refers to any computational method or algorithm used to analyze, interpret, classify, or extract information from text data in a human language, including but not limited to tokenization, parsing, semantic analysis, and machine learning-based text analysis.

The term “prompt” refers to data, instructions, or messages generated by the processor and used to guide subsequent processing, user interaction, or decision-making, including prompts for determining a falsehood level or for proposing a next action.

The term “falsehood level” refers to an estimation or classification, which may be qualitative or quantitative, of the degree to which a statement contained in the text data is likely to be false, deceptive, or misleading.

The term “statement” refers to a unit of content expressed by a party to the communication, including a sentence, phrase, or utterance, that is represented in the text data and is subject to analysis for falsehood.

The term “next action” refers to an action to be taken after or in response to the received communication, including but not limited to reporting to authorities, blocking a caller, requesting additional verification, or terminating further communication.

The term “emotion analysis engine” refers to a software or hardware component that analyzes input data, such as voice data, text data, or physiological signals, to estimate an emotional state of a user, using techniques including but not limited to sentiment analysis, prosody analysis, or machine learning models.

The term “emotional state” refers to a psychological or affective condition of the user, such as calmness, anxiety, anger, fear, or confidence, which is inferred from data analyzed by the emotion analysis engine.

The term “user” refers to a person who is a party to the received communication or who operates the terminal or device associated with the system and who receives proposed actions or prompts generated by the processor.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

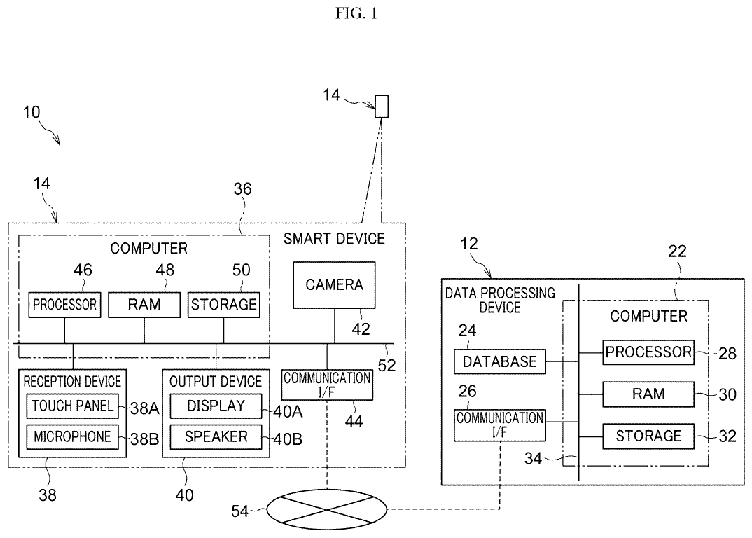

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

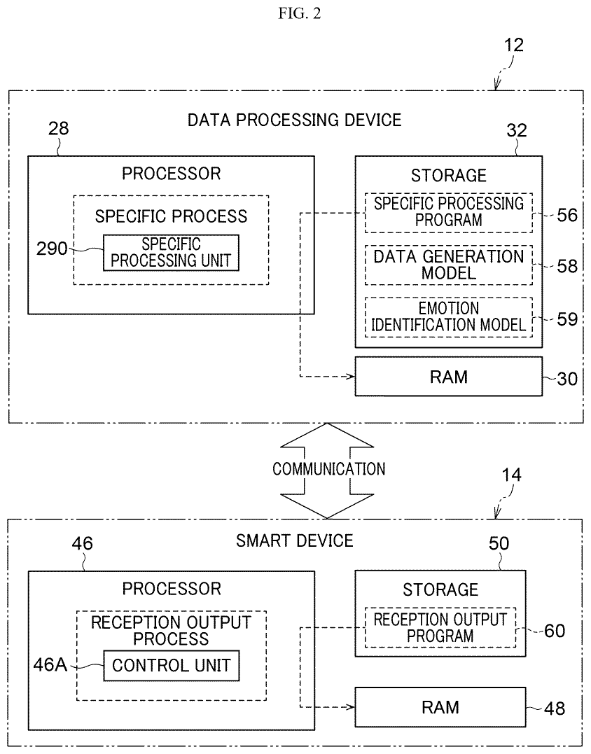

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented communication systems that provide automatic answering functions suffer from several technical shortcomings in how they acquire, analyze, and utilize call content. First, such systems typically perform only fixed-rule call routing or template-based responses without deeply analyzing audio streams at the level of recognized text, dialog context, or reliability of caller statements. As a result, the systems do not make effective use of the available computational resources for semantic and contextual evaluation, and cannot provide machine-assistance that improves the way the computer system itself processes communication data.

Second, existing architectures often treat speech recognition, natural language understanding, and decision logic as loosely coupled or manually configured components. Audio is transcribed, but the recognized text is not systematically combined with dialog history, reliability estimation, emotional state analysis, and user feedback into a unified machine process. This fragmented processing leads to redundant data transfers between subsystems, inefficient use of processing units, and an inability to automatically generate structured prompt sentences that drive downstream natural language models in a repeatable and machine-optimized manner.

Third, traditional systems generally rely on static rules or predetermined thresholds to classify a caller as trustworthy or untrustworthy, and to suggest follow-up actions. These implementations do not effectively exploit modern generative artificial intelligence models to dynamically construct prompts based on accumulated dialog context and reliability evaluation information. As a result, the computer system cannot adaptively refine its decision-making logic, cannot generate appropriate action candidates at scale, and cannot efficiently update the user interface on the terminal with system-generated summaries and recommendations.

Fourth, conventional systems do not integrate, as a computer-technical pipeline, speech recognition, dialog logging, reliability scoring, emotional state analysis, and generative text-based reasoning within a single processing flow controlled by a processor. The absence of a structured process for generating and supplying prompt sentences to various language models leads to increased latency, increased computational overhead due to ad hoc orchestration logic, and reduced consistency in the stored records used for subsequent model improvement.

Accordingly, there is a need for an improved computer-implemented system and server that can technically enhance the way communication data is processed. In particular, there is a need for a processor-controlled architecture that: (i) switches from human response to artificial intelligence automatic response based on terminal operation information; (ii) converts audio information into character information and maintains dialog history in a structured storage; (iii) automatically generates analysis prompts and action-generation prompts for natural language processing engines and generative artificial intelligence models; (iv) computes reliability evaluation information and emotional state information; and (v) uses such information to generate, adjust, and deliver action candidate information and dialog summaries back to the terminal. Such an architecture should improve the technical performance of the communication processing system as a whole, for example by reducing manual intervention, reducing processing redundancy, and enabling more accurate and timely machine-driven responses using standardized prompt generation and model interaction.

The specific processing by the specific processing unit 290 of the data processing device 12 in Example 1 is realized by the following means.

The present invention provides a server comprising a processor configured to control switching of response to received communication from a human responder to an artificial intelligence automatic responder based on operation information transmitted from a communication terminal, to transmit audio information acquired from a communication infrastructure to a speech recognition processing unit to convert the audio information into character information and to sequentially store the character information and dialog history information in a storage unit, to generate an analysis request prompt sentence for evaluating a reliability level of utterance content based on the stored character information and dialog history information and to input the analysis request prompt sentence and the character information to a natural language processing engine and a generative artificial intelligence model to acquire reliability evaluation information, to generate a prompt sentence for generating next action candidates to be presented to a user based on the reliability evaluation information and the dialog history information and to input the prompt sentence to the generative artificial intelligence model to acquire action candidate information, to transmit the action candidate information and the reliability evaluation information to the communication terminal and to execute control processing corresponding to an action selected by the user at the communication terminal, and, in some embodiments, to generate a prompt sentence for summarizing dialog content based on the reliability evaluation information and the dialog history information and input the prompt sentence to the generative artificial intelligence model to acquire summary information, and to calculate emotion state information for the character information using an emotion analysis engine and generate a prompt sentence for adjusting the action candidate information based on the emotion state information and the reliability evaluation information and input the prompt sentence to the generative artificial intelligence model to acquire adjusted action candidate information. This enables the computer system to technically improve communication processing by automatically orchestrating speech recognition, dialog logging, reliability assessment, emotional state analysis, and generative model interaction through standardized prompt generation, thereby reducing manual intervention, lowering redundant processing between subsystems, and providing more accurate and timely machine-generated summaries and action recommendations to the communication terminal.

The term “processor” refers to one or more hardware-based information processing units, such as a central processing unit or a dedicated processing circuit, configured to execute instructions to control communication processing, data conversion, data storage, and interaction with external processing engines and models.

The term “communication terminal” refers to an endpoint communication apparatus operated by a user, including but not limited to a mobile device, a desktop device, or any network-connected user interface device, that sends operation information and receives information such as action candidate information and summary information from the server.

The term “communication infrastructure” refers to a networked communication environment, including telecommunication networks, packet-switched networks, or any combination thereof, through which audio information and signaling related to calls or sessions are transmitted.

The term “human responder” refers to a human user who manually handles received communication, for example by answering a call or directly interacting with a caller, prior to or instead of an artificial intelligence automatic responder.

The term “artificial intelligence automatic responder” refers to a computer-implemented response system that automatically conducts dialog with a communication counterpart using speech recognition, natural language processing, and generated responses, without requiring continuous manual intervention by a human responder.

The term “operation information” refers to control-related information transmitted from the communication terminal, including at least a user operation such as selection of an automatic response mode or selection of an action candidate, used by the processor to control switching and subsequent processing.

The term “audio information” refers to digital or analog representations of sound associated with a communication session, including voice signals of a caller, that are provided to a speech recognition processing unit for conversion into character information.

The term “speech recognition processing unit” refers to a hardware or software component, or a combination thereof, configured to convert audio information into character information using speech recognition techniques.

The term “character information” refers to text-based data obtained by converting audio information through speech recognition, including words, sentences, or symbols representing the content of utterances in a dialog.

The term “dialog history information” refers to structured data representing a sequence of utterances, timestamps, speaker identifiers, and related metadata accumulated over the course of a communication session.

The term “storage unit” refers to one or more memory devices or storage devices, such as volatile memory or non-volatile storage, configured to store character information, dialog history information, reliability evaluation information, summary information, and related records.

The term “recording information storage unit” refers to a storage unit specifically used to sequentially store character information and dialog history information associated with one or more communication sessions.

The term “analysis request prompt sentence” refers to a text-based instruction sequence generated by the processor, structured for input to a natural language processing engine or a generative artificial intelligence model, and designed to cause such engine or model to evaluate a reliability level of utterance content.

The term “prompt sentence” refers to a text-based instruction or query formed according to a predefined format, for specifying a task, context, or constraint to a natural language processing engine or a generative artificial intelligence model, including but not limited to prompts for reliability evaluation, action generation, summary generation, or adjustment of action candidates.

The term “natural language processing engine” refers to a software-controlled processing component configured to analyze character information using natural language processing techniques, such as parsing, intent recognition, or semantic analysis.

The term “generative artificial intelligence model” refers to a machine-learned model capable of generating natural language text or structured outputs in response to a prompt sentence and input data, using generative modeling techniques such as large language models.

The term “reliability evaluation information” refers to information indicating an evaluation of the reliability level or trustworthiness of utterance content, which may include a numerical score, a categorical label, or explanatory text derived from analysis by a natural language processing engine or a generative artificial intelligence model.

The term “utterance content” refers to the semantic and textual content of spoken or written messages produced by a participant in a dialog, as represented in character information.

The term “next action candidates” refers to one or more proposed operations or follow-up behaviors suggested by the processor for a user in response to a communication, such as calling back, blocking a number, or requesting additional verification.

The term “action candidate information” refers to structured information representing next action candidates, including identifiers, labels, and optional rationales or conditions associated with each candidate.

The term “summary information” refers to condensed text or data that represents an abstracted overview of dialog content, generated from dialog history information and reliability evaluation information.

The term “emotion analysis engine” refers to a processing component configured to analyze character information or related features to determine emotional states, such as sentiment or affective categories, associated with utterances.

The term “emotion state information” refers to data indicating an emotional state associated with utterance content, which may include sentiment scores, emotion categories, or similar descriptors produced by an emotion analysis engine.

The term “adjusted action candidate information” refers to action candidate information that has been modified or refined by the processor based on emotion state information and reliability evaluation information, such that recommendations are tailored to both reliability and emotional context.

The term “control processing” refers to operations performed by the processor to cause the communication system or associated devices to execute a function corresponding to a selected action, including operations such as initiating calls, updating lists, or modifying communication handling policies.

In one embodiment, a server includes a processor, a memory, a non-transitory storage device, a network interface, and an interface to a communication infrastructure such as a telephone network or a packet-based voice network. The server operates in cooperation with at least one terminal and at least one user. The server, the terminal, and the communication infrastructure are implemented using general-purpose computing hardware, for example, a server computer with a central processing unit (CPU), a graphics processing unit (GPU) for neural network execution, a volatile memory, a non-volatile storage device such as a solid-state drive, and a wired or wireless network adapter. The terminal is implemented, for example, by a smartphone, a tablet, or a desktop client device having a touchscreen or other input/output interface and an operating system that supports communication applications.

The server executes software components including a communication control module, a speech recognition interface module, a natural language processing interface module, a generative AI model interface module, an emotion analysis module, a dialog management module, a prompt generation module, and a data storage management module. The storage device of the server holds structured data in one or more databases, such as a relational database management system or a key-value store. The stored data includes call session records, utterance records, dialog history records, reliability evaluation records, emotion state records, action candidate records, and user feedback records.

The server uses the communication control module to connect to the communication infrastructure. The communication infrastructure can include a voice-over-IP gateway, a session initiation protocol (SIP) server, or a private branch exchange. In one implementation, the server controls media routing through telephony middleware, such as an open-source telephony platform or a cloud telephony application programming interface. The server receives information indicating an incoming communication, such as an incoming call, and associates the communication with a unique call identifier. The server transmits an incoming call notification to the terminal over a packet-based network using a protocol such as Hypertext Transfer Protocol (HTTP) or WebSocket.

The terminal executes a communication application that presents a user interface on a display. The terminal receives, from the server, the incoming call notification and displays caller information together with an indication that an artificial intelligence automatic response mode is available. The user operates the terminal to select whether to answer the communication manually or to switch to an artificial intelligence automatic responder. The user, for example, touches a graphical control labeled with an indication of AI response on the touchscreen of the terminal.

The terminal transmits operation information to the server in response to the user input. The operation information includes at least the call identifier and a flag indicating that an artificial intelligence automatic responder is requested. The server receives the operation information via the network interface and the communication control module, and the processor updates a call session record in the storage device to indicate that the communication is to be handled by an artificial intelligence automatic responder rather than by a human responder at the terminal.

The server controls the communication infrastructure so that audio information associated with the communication is routed to the server instead of to the terminal. In a voice-over-IP implementation, the server modifies session parameters so that the media stream endpoint is the server or an associated media processing node. The audio information is received by the server as a sequence of encoded frames, for example, using a standard telephony codec. The server decodes the audio frames into a linear pulse-code modulated (PCM) representation using a media processing library. The server then provides the decoded audio information to the speech recognition interface module.

The server uses the speech recognition interface module to transmit the audio information to a speech recognition processing unit. The speech recognition processing unit can be an external speech recognition service or an internal speech recognition engine, and may employ deep neural network acoustic models and language models. The server provides the audio information in streaming or batch form, and receives recognized text segments as character information. The character information includes words and sentences corresponding to utterances of the communication counterpart. The server also obtains confidence scores for the recognized segments from the speech recognition processing unit.

The server uses the dialog management module and the data storage management module to construct dialog history information. For each call identifier, the server creates a dialog record containing an ordered list of utterance records. Each utterance record includes at least: a speaker label indicating the caller or the system, a timestamp, the recognized character information, and an associated confidence score. The server stores the dialog history information in the storage device, using a data structure that allows efficient retrieval of utterances by call identifier and time.

The server uses the prompt generation module to generate an analysis request prompt sentence for evaluating the reliability of utterance content. The server constructs the analysis request prompt sentence by embedding the character information of a target utterance and selected context from the dialog history information into a templated text instruction. For example, the server generates a prompt sentence in the following form:
“Analyze the following caller statement and the provided context. Determine the reliability level on a scale from 0 to 100, where higher values indicate higher reliability, and provide a short explanation of the reasoning.
Context: [summary of prior dialog turns].
Caller statement: [latest utterance text].
Please output the reliability score and a brief explanation.”

The server passes the analysis request prompt sentence and associated character information to a natural language processing engine and to a generative AI model. The natural language processing engine may perform tokenization, syntactic parsing, and semantic analysis to derive linguistic features, such as part-of-speech tags, dependency relations, and named entities. The generative AI model may be implemented as a transformer-based neural network that includes multiple attention layers, feed-forward layers, and layer normalization nodes. The generative AI model has been trained using a large corpus of text data and fine-tuned with instruction-following data to respond effectively to prompt sentences.

The server uses the generative AI model interface module to send the analysis request prompt sentence to the generative AI model and to receive output text. The output text can be structured to indicate a numerical reliability score and explanatory content. The server parses the output and stores reliability evaluation information, including the score and explanation, in association with the corresponding utterance record. The reliability evaluation information may be quantized into categories, such as low, medium, and high, by applying threshold rules to the numerical score.

The server also uses the prompt generation module to generate a prompt sentence for generating next action candidates to be presented to the user. This prompt sentence is constructed based on the reliability evaluation information and the dialog history information.

For example, the prompt sentence can take the form:
“Based on the following conversation and reliability assessments, propose several specific next actions for the user.
Conversation summary: [short summary of dialog].
Reliability assessment: [reliability scores and notes].
Please list 3 or 4 concrete suggested actions, each with a short rationale.”

The server sends this prompt sentence to the generative AI model. The generative AI model generates text listing several recommended actions, such as ignoring the caller, calling back using an official contact, blocking the number, or requesting additional verification. The server parses the generated text and converts it into structured action candidate information, which includes action identifiers, labels, and associated rationales.

The server transmits the action candidate information and the reliability evaluation information to the terminal. The terminal receives this information and updates the user interface to display a summary of the dialog, an indication of the reliability evaluation, and one or more selectable controls corresponding to the action candidates. The user views the information and selects a desired action by operating the terminal. The terminal then transmits information indicating the selected action to the server.

The server receives the selected action information and performs control processing corresponding to the selected action. For example, if the user selects an action to block the caller, the server updates a blocklist data structure in the storage device so that future communications from that source are automatically rejected or flagged. If the user selects an action to initiate a safe outbound communication, the server instructs the communication infrastructure to place a new call to a verified contact address, and the terminal displays state information about the newly initiated call. In this manner, the server not only evaluates the dialog content but also affects real-world communication behavior through direct control of communication equipment and routing.

In a further embodiment, the server generates a prompt sentence for summarizing the dialog content based on the reliability evaluation information and the dialog history information. For example, the server can construct a summary prompt sentence such as:
“Summarize the following dialog in a few sentences, highlighting the main requests made by the caller and noting any parts that were evaluated as low reliability.
   Dialog: [sequence of utterances with reliability labels].”

The server sends this prompt sentence to the generative AI model, receives a concise textual summary, and transmits the summary information to the terminal. The terminal presents this summary as part of a call log or notification screen, thereby allowing the user to quickly grasp the essential content and reliability of past communications.

In another embodiment, the server calculates emotion state information for character information using an emotion analysis engine. The emotion analysis engine may employ a recurrent neural network or transformer-based classifier that has been trained to map text features to emotion categories such as positive, neutral, negative, or more fine-grained emotional states. The server converts the character information into input features, such as token embeddings, and the emotion analysis engine outputs a probability distribution over the emotion categories. The server interprets this distribution to compute emotion state information, which may include a dominant emotion category and a confidence score.

The server uses the prompt generation module to generate a prompt sentence for adjusting the action candidate information based on the emotion state information and the reliability evaluation information. For example, the server may generate a prompt sentence in the following form:
“Given the following conversation, reliability assessments, and detected emotional states, refine the recommended actions so that they are appropriate to both the reliability and the emotional tone.
Conversation summary: [summary text].
Reliability assessment: [scores and notes].
Emotional tone: [detected emotions and their intensities].
Please provide adjusted recommended actions with brief rationales.”

The server sends this prompt sentence to the generative AI model and receives adjusted action recommendations. The server then updates the action candidate information so that the set of proposed actions better reflects both the trustworthiness of the caller's statements and the emotional context. This combination of reliability and emotional analysis improves the precision of system recommendations compared to conventional systems relying only on static, rule-based decisions.

The server implements the above functions in a modular manner that enhances computer technology beyond mere automation of human mental judgment. In particular, the server explicitly structures communication data into dialog history records, reliability records, and emotion state records, which are stored in indexed database tables. The server coordinates multiple specialized processing engines—speech recognition, natural language parsing, neural reliability estimation, and emotion classification—through a standardized prompt generation and response parsing mechanism. By using prompt sentences as a control interface for the generative AI model, the server reduces the need for rigid, compiled decision trees and enables the model to dynamically adapt to different dialog contexts without reconfiguring the core system logic.

This architecture leads to technical effects including reduced processing latency and reduced redundant data transformation. For example, the server reuses the same character information across multiple analyses (reliability evaluation, summary generation, and emotion analysis) without re-transmitting and re-encoding the original audio. The dialog history is stored as structured records, allowing the server to retrieve only the necessary context for each prompt generation, thereby minimizing network load between the server and external model hosts. The combination of incremental dialog logging and context-aware prompt construction reduces the average size of prompts while maintaining analytical accuracy, which directly reduces communication bandwidth usage and accelerates model response time.

Additionally, the server uses feedback signals, such as the actions actually selected by the user, to update statistical parameters used in prompt construction and scoring thresholds. For example, the server can log cases where the user selected an action inconsistent with the initial recommendation and can adjust reliability thresholds or refine prompt wording in subsequent sessions. The server stores these feedback records and uses them in an offline training process in which a supervised learning algorithm minimizes a loss function defined over differences between recommended actions and user-selected actions. The learned parameters are then deployed back into the prompt generation module. This closed feedback loop improves the calibration of reliability evaluations and the relevance of action candidates over time, yielding an improvement in system accuracy.

In some variations, the server executes the generative AI model locally on a GPU. The generative AI model may be an encoder-decoder transformer having multiple attention heads and layers, trained using a gradient descent optimization algorithm on a large text dataset. During training, the model minimizes a cross-entropy loss function between predicted tokens and ground-truth tokens. For reliability scoring tasks, the server fine-tunes the model using labeled dialog examples where human experts have assigned reliability scores or labels. The fine-tuning uses a supervised objective such as mean squared error between predicted scores and labeled scores. Through this training, the model internalizes patterns associated with scam behavior, inconsistent statements, and other indications of low reliability. As a result, when the model is later used in the system with appropriate prompt sentences, it can provide reliability evaluations more quickly and accurately than traditional, hand-crafted rule engines.

The server's use of specific data structures and processing pipelines also improves data management. For example, the server can store utterance records in a table keyed by a composite key of call identifier and utterance index, and can store reliability evaluation information in a related table with foreign keys to specific utterances. This normalized scheme enables efficient queries, such as retrieving all utterances with low reliability in a given time period, which in turn supports periodic retraining of models and maintenance tasks. By explicitly separating dialog content, reliability metrics, and emotional states, the system avoids data duplication and enables differential privacy controls or selective data retention policies.

The terminal participates as an active component in the improved computer-technical process. The terminal is configured to send operation information that specifically triggers the switching of media routing at the server, thus enabling a user to offload the communication processing to the server only when necessary. This selective switching reduces the overall computational load, as the server does not need to process all calls, only those for which artificial intelligence automatic response is requested. Furthermore, the terminal renders complex evaluation information—such as reliability scores and action candidates—in a form that the user can quickly understand, thereby reducing the need for repeated server queries and avoiding unnecessary network traffic.

Because the server, the terminal, and the communication infrastructure work together to implement speech acquisition, recognition, semantic evaluation, and control of subsequent communication behavior, the system is not limited to abstract manipulation of text. The server's decisions based on reliability and emotional analysis directly influence how future calls are routed, whether specific numbers are blocked, and how new outbound communications are initiated. This coupling between advanced natural language processing and concrete control of communication equipment constitutes an improvement in computer and network technology, enabling faster, more accurate, and more resource-efficient handling of communication sessions than conventional rule-based or purely manual systems.

Various alternative embodiments can be implemented without departing from the technical spirit of the invention. For example, the speech recognition processing unit can be replaced by different acoustic model architectures, such as convolutional neural networks or hybrid models, as long as character information is produced for use in the subsequent pipeline. The emotion analysis engine can utilize different feature representations, such as word embeddings, contextual embeddings, or handcrafted sentiment lexicon features. The generative AI model may be replaced by any sequence-to-sequence model or encoder-only model adapted to produce textual reliability assessments and action recommendations in response to prompt sentences. The dialog history may be stored in document-oriented storage instead of a relational database, with equivalent structured indexing. The server may be configured as a cluster of machines sharing the storage unit through distributed file systems or database sharding, enabling horizontal scaling of the processing pipeline in high-traffic environments.

In another variation, the terminal can locally execute a lightweight model trained for preliminary reliability estimation, while the server performs full analysis using more complex models only for selected utterances. In such an arrangement, the terminal sends summary features or pre-scores instead of raw character information for some interactions, thereby further reducing communication load and accelerating user feedback. The server can still perform centralized storage and high-precision analysis for sessions that exceed a certain risk threshold determined by the preliminary estimation. Through these and similar variations, the system can be tailored to different deployment environments while preserving the fundamental technical benefits of structured dialog processing, generative AI-based prompt-driven reasoning, and integrated control over communication hardware.

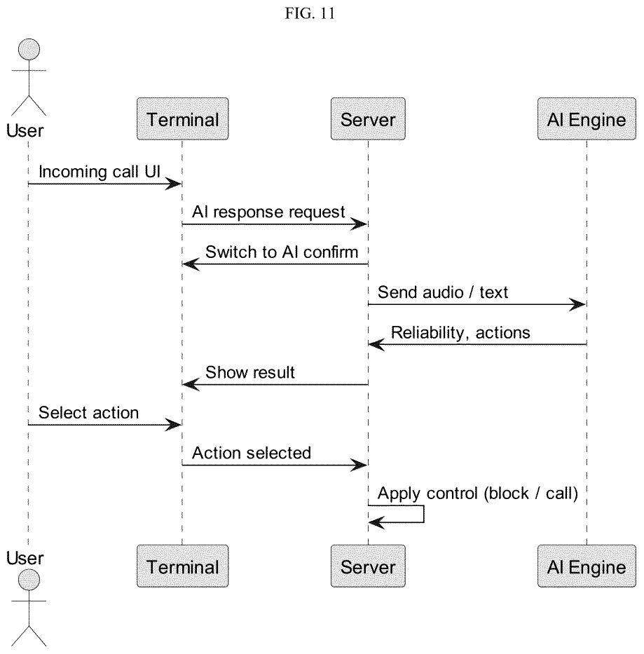

The following describes the processing flow using FIG. 11.

### Step 1:

The terminal receives an incoming call notification from the server.

The inpu4t is signaling information from the server including a call identifier, caller address information, and call type. The terminal uses its communication application to decode the signaling and to update a local call session object in memory. The terminal outputs a user interface state that displays the caller information and shows selectable controls including a normal answer control and an AI response control.

### Step 2:

The user selects the AI response control on the terminal.

The input is the display of the incoming call screen with the AI response control. The user performs a touch operation or equivalent input on the AI response control. The terminal detects the interaction event using its user interface framework, maps the event to a command object containing the call identifier and an AI-request flag, and outputs operation information to the server over a network connection.

### Step 3:

The server receives the operation information and switches the call handling mode to artificial intelligence automatic response.

The input is the operation information from the terminal including the call identifier and the AI-request flag. The server reads the call identifier, retrieves the corresponding call session record from a storage unit, and updates a mode field to indicate AI handling. The server then outputs control commands to the communication infrastructure to redirect the media stream endpoint from the terminal to a media processing endpoint associated with the server.

### Step 4:

The server acquires audio information from the communication infrastructure.

The input is the redirected media stream from the communication infrastructure, encoded using a telephony codec and associated with the call identifier. The server uses a media processing module to decode the encoded frames into linear PCM audio samples and aggregates consecutive samples into fixed-length audio buffers. The server outputs audio buffers suitable for input to a speech recognition processing unit.

### Step 5:

The server sends the audio buffers to the speech recognition processing unit and receives character information.

The input is the series of audio buffers representing caller speech. The server packages the audio buffers into a request format required by the speech recognition processing unit and transmits them via a streaming or batch interface. The speech recognition processing unit processes the audio using an acoustic model and a language model to generate transcriptions. The server receives the transcriptions as character information with associated confidence scores and utterance boundaries, and outputs structured utterance records containing text, timestamps, and scores.

### Step 6:

The server updates dialog history information in the storage unit.

The input is the structured utterance records produced from the speech recognition processing unit and the current call session record. The server assigns an utterance index for each new record, sets a speaker label indicating the caller, and appends the record to a dialog history list stored in a database table keyed by the call identifier. The server outputs updated dialog history information that can be retrieved efficiently for subsequent analysis.

### Step 7:

The server generates an analysis request prompt sentence for reliability evaluation.

The input is the latest utterance record and the dialog history information for the corresponding call identifier. The server uses a prompt generation module to extract a subset of previous utterances, to compute a short context summary, and to combine this summary with the latest utterance text according to a predefined template. The server performs string concatenation and placeholder replacement operations to construct a complete prompt sentence instructing a reliability assessment task. The server outputs the analysis request prompt sentence as a text string.

### Step 8:

The server sends the analysis request prompt sentence and character information to a natural language processing engine and a generative AI model.

The input is the analysis request prompt sentence and the character information for the latest utterance. The server tokenizes the prompt sentence and the character information if required by the model interface, and formats them into a request payload that includes token sequences and model parameters. The server transmits this payload to the natural language processing engine and to the generative AI model through an application programming interface. The server outputs one or more response messages containing reliability evaluation text or structured results returned from the models.

### Step 9:

The server computes reliability evaluation information from the model outputs.

The input is the response messages containing reliability-related text or fields from the natural language processing engine and the generative AI model. The server uses parsing algorithms, such as regular expressions or a small parser, to extract a numerical reliability score, category labels, and explanatory text. The server normalizes the score to a predefined range, for example 0 to 100, and maps it to discrete reliability levels using threshold comparisons. The server outputs reliability evaluation information and stores it in association with the corresponding utterance record in the storage unit.

### Step 10:

The server generates a prompt sentence for next action candidates based on reliability evaluation information and dialog history information.

The input is the reliability evaluation information for one or more utterances and the dialog history information for the call. The server computes a conversation summary by selecting key utterances and compressing them into a shorter narrative using a summarization rule or a previous generative summary, and then composes another template-based text that asks for recommended actions. The server performs string assembly to inject the summary and reliability indicators into the template, thereby outputting a prompt sentence that instructs a generative AI model to produce next action candidates.

### Step 11:

The server sends the next action prompt sentence to the generative AI model and receives action candidate text.

The input is the next action prompt sentence. The server tokenizes the prompt if required, sets decoding parameters such as maximum token length and temperature, and sends the token sequence to the generative AI model as an inference request. The generative AI model processes the sequence through multiple neural network layers to generate output tokens, and the server receives the resulting text describing recommended actions. The server outputs the raw action candidate text for further structuring.

### Step 12:

The server converts the action candidate text into structured action candidate information.

The input is the raw action candidate text returned by the generative AI model. The server uses text parsing rules to identify individual suggested actions, extract labels, and capture any corresponding explanations or rationales. The server may assign each action a unique identifier and a priority level, computed based on order of appearance or keywords indicating urgency. The server outputs structured action candidate information that can be presented consistently on the terminal user interface.

### Step 13:

The server optionally generates a prompt sentence for dialog summary and obtains summary information.

The input is dialog history information and reliability evaluation information. The server selects utterances and reliability labels, forms a compressed list of dialog turns, and inserts this list into a summarization prompt template, for example: “Summarize the following dialog and highlight low-reliability parts.” The server sends this prompt sentence to the generative AI model, receives summary text, and outputs summary information, which is stored in the storage unit and linked to the call identifier.

### Step 14:

The server optionally calculates emotion state information and adjusts action candidate information.

The input is character information for selected utterances and initial action candidate information. The server forwards the character information to an emotion analysis engine, which outputs emotion category probabilities. The server interprets this result to generate emotion state information, such as “negative, high intensity.” The server then composes a new prompt sentence that includes the conversation summary, reliability data, and emotional state, and sends it to the generative AI model to request adjusted recommendations. The server parses the resulting text and modifies the existing action candidate information by reordering actions or adding cautionary notes. The server outputs adjusted action candidate information that better reflects emotional and reliability context.

### Step 15:

The server transmits reliability evaluation information, action candidate information, and summary information to the terminal.

The input is the set of evaluation and recommendation data associated with the call, including reliability scores, explanations, action candidates, and optional dialog summary. The server serializes these data structures into a response message, for example using a structured text format, and sends the message to the terminal over the network. The server outputs a network transmission that contains all necessary fields for user interface rendering at the terminal.

### Step 16:

The terminal receives the evaluation and recommendation data and updates its user interface.

The input is the response message from the server containing reliability evaluation information, action candidate information, and optional summary information. The terminal decodes the message, maps the fields to internal data structures, and updates its display to show the conversation summary, reliability level indicators, and a set of selectable controls corresponding to the action candidates. The terminal outputs a rendered graphical interface that allows the user to review the AI-generated information and to choose an action.

### Step 17:

The user selects a final action based on the displayed action candidates.

The input is the visual presentation of action candidates and reliability indicators. The user evaluates the presented information and performs a touch or equivalent input on one of the displayed controls, such as “Block this caller,” “Call official contact,” or “Ignore.” The terminal captures the event and converts it into a selected action code and associated call identifier. The terminal outputs a selected action message and transmits it to the server.

### Step 18:

The server performs control processing corresponding to the selected action.

The input is the selected action message from the terminal. The server reads the action code and call identifier, retrieves the call session record, and executes the associated backend operation. For example, for a block action, the server inserts the caller address into a blocklist table and sends an update to the communication infrastructure to reject future calls from that address. For a safe call action, the server instructs the communication infrastructure to initiate an outbound call to a stored safe contact. The server outputs updated configuration settings, modified call routing rules, and any new call control messages needed to implement the selected action.

### Step 19:

The server logs the entire interaction for future optimization and model improvement.

The input is the final state of the dialog history, reliability evaluations, emotion state information, action candidate information, and the user-selected action. The server aggregates these data elements into a training record, anonymizes or filters sensitive fields as required, and stores the record in a designated dataset within the storage unit. The server outputs a structured log that can later be used by an offline training pipeline to adjust model parameters, refine prompt templates, and improve threshold values, thereby enhancing the accuracy and efficiency of future online processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional communication handling systems that rely on rule-based screening or simple keyword matching for fraud detection suffer from several technical limitations. First, such systems are typically configured to treat audio, text, and interaction history as separate data streams, without unified modeling of the conversational context. As a result, the systems cannot reliably detect complex patterns of deceptive or suspicious behavior that depend on dialogue flow, timing, or semantic consistency across multiple utterances. This leads to low detection accuracy and frequent false positives or false negatives, which in turn degrade the effectiveness of automated call screening and impose additional burden on human operators and end users.

Second, conventional systems generally apply artificial intelligence components in a static or narrowly scoped manner. For example, a speech recognition engine may simply output text, or a classifier may output a binary “fraud/not fraud” label, without dynamically adapting the behavior of downstream components. In particular, existing architectures do not tightly integrate generative AI models, prompt construction, falsity evaluation, and user interaction control into a single coordinated pipeline. As a consequence, the systems cannot flexibly adapt response content, explanation detail, or communication modality based on evolving conversational context and risk assessment, resulting in rigid and brittle behavior under real-world conditions.

Third, most existing systems lack a mechanism to automatically generate and adjust natural-language prompts that drive generative AI models based on real-time evaluation information, conversation logs, and user state. Prompt engineering is often done manually and offline, which prevents the system from updating prompts at runtime to reflect the current risk level, the parts of the conversation identified as suspicious, or the emotional state of the user. This architectural limitation leads to suboptimal utilization of generative AI capabilities, and prevents the system from producing tailored, context-aware responses and action recommendations in a consistent and repeatable way.

Fourth, conventional communication platforms usually do not maintain a structured, time-aligned record of the conversation, the associated evaluation results, and the generated AI outputs, nor do they expose these relationships back to the user. Accordingly, an end user or operator cannot see which exact parts of the counterpart's speech were judged as deceptive, why a certain risk score was assigned, or how an action recommendation was derived. This lack of explainability limits trust in the system and makes it difficult to audit or improve the underlying models and decision rules.

Fifth, typical architectures do not couple risk evaluation with automatic response generation and delivery in a way that can replace or offload human operators for suspicious communications. While some systems may display warnings, they rarely generate complete, policy-compliant responses that can be directly delivered to the counterpart over the same communication channel. As a result, human intervention remains necessary to craft responses, which undermines scalability and real-time responsiveness.

Furthermore, existing systems generally ignore the emotional state of the user when generating responses or action recommendations. In stressful situations such as fraud attempts, the user's emotional state can affect comprehension, decision-making, and the appropriateness of the system's guidance. Without leveraging emotion analysis to adjust style, tone, and level of detail of the generated outputs, conventional systems risk providing instructions that are technically accurate but poorly suited to the user's current condition, thereby reducing the practical effectiveness of the guidance.

Accordingly, there is a need for a computer-implemented communication handling system that (i) unifies acquisition and processing of audio and text communication data, (ii) dynamically generates and refines prompt sentences for a generative AI model based on conversation content and falsity evaluation, (iii) automatically derives and delivers context-aware responses and next-action proposals, (iv) explicitly identifies and explains suspicious portions of a conversation to the user, and (v) adjusts the generated outputs based on the user's emotional state. Such a system should improve the technical functioning of the communication handling pipeline itself, by orchestrating multiple AI components (speech recognition, natural language processing, generative modeling, classification, emotion analysis) in a coordinated configuration that produces more accurate, explainable, and adaptive behavior than conventional approaches.

The specific processing by the specific processing unit 290 of the data processing device 12 in Application Example 1 is realized by the following means.

The present invention provides a server comprising a processor configured to switch an incoming communication from a human response to an artificial intelligence automatic response, to acquire audio information corresponding to the incoming communication and convert the audio information into text information by using speech recognition processing, to generate a first prompt sentence for evaluating falsity or suspiciousness of utterance content of a communication counterpart by applying natural language processing to the text information together with supplementary information relating to the incoming communication, to input the first prompt sentence and the text information to a generative information processing model and cause the generative information processing model to generate response information to be transmitted to the communication counterpart, to transmit the response information obtained from the generative information processing model to the communication counterpart as an audio output or a character output in accordance with a medium of the incoming communication, to store conversation content of the communication as recording information in association with time-series information and speaker identification information, to apply at least one of the generative information processing model and a classification model to the recording information and calculate evaluation information indicating the falsity or the suspiciousness of the utterance content, to generate a second prompt sentence for proposing a next action based on the evaluation information, to input the second prompt sentence and the evaluation information to the generative information processing model and cause the generative information processing model to generate action proposal information to be presented to a user, to notify the action proposal information to a user terminal for display or audio guidance, and to generate an automatic response prompt sentence for a suspicious communication based on pre-stored response guideline information and the evaluation information, input the automatic response prompt sentence to the generative information processing model to cause the generative information processing model to generate automatic response information, and transmit the automatic response information to the communication counterpart. This enables an improvement of computer-based communication handling by providing an integrated, runtime-configurable pipeline in which the server automatically coordinates speech recognition, natural language processing, falsity evaluation, prompt sentence generation, generative model inference, and response delivery so that suspicious communications are detected more accurately, explained more transparently, and handled by adaptive, context-aware automatic responses and action recommendations without requiring constant human intervention.

The term “incoming communication” refers to any communication initiated from an external source toward a user or a user terminal, including but not limited to a voice call, a video call, a text message, or a data message transmitted over a communication network. The term “human response” refers to a response generated directly by a human user or operator, without automatic generation of response content by an artificial intelligence component.

The term “artificial intelligence automatic response” refers to a response whose content is generated automatically by a computational model implementing artificial intelligence techniques, without requiring a human user to manually compose the response content.

The term “audio information” refers to digital data representing sound signals associated with a communication, including spoken utterances of a user or a communication counterpart.

The term “speech recognition processing” refers to a computational process that converts audio information representing spoken language into corresponding text information, using pattern recognition, acoustic modeling, and language modeling.

The term “text information” refers to character-based data representing linguistic content, such as sentences or words, obtained for example by converting audio information through speech recognition processing or by receiving text messages directly.

The term “supplementary information relating to the incoming communication” refers to additional data associated with a communication, including but not limited to caller identifiers, timestamps, communication channel types, prior conversation segments, or metadata describing the communication context.

The term “utterance content” refers to the semantic and lexical content of spoken or written statements made by a communication counterpart or a user during a communication. The term “communication counterpart” refers to an entity, which may be a person or a remote system, that participates in a communication with the user or user terminal and exchanges utterances or messages.

The term “falsity” refers to a degree or likelihood that an utterance content is untrue, deceptive, or inconsistent with known or inferred facts or norms.

The term “suspiciousness” refers to a degree or likelihood that an utterance content, communication pattern, or behavior is associated with fraudulent, malicious, or otherwise abnormal activity.

The term “prompt sentence” refers to a text string or structured textual input constructed to instruct or guide the behavior of a generative information processing model when generating output information.

The term “generative information processing model” refers to a computational model that, in response to an input including at least one prompt sentence, generates new information such as natural language text, based on statistical or machine-learned representations of data.

The term “response information” refers to information generated by the generative information processing model that is intended to be output to or transmitted to a communication counterpart or a user as a reply or reaction to an incoming communication. The term “medium of the incoming communication” refers to a communication modality, including voice, video, or text, through which an incoming communication is carried between the communication counterpart and the user terminal.

The term “audio output” refers to sound signals generated for playback to a listener, such as synthesized speech corresponding to response information.

The term “character output” refers to visual text data presented on a display or transmitted as written content, corresponding to response information.

The term “conversation content” refers to the collection of utterances, messages, and related context exchanged between a user and a communication counterpart during a communication session.

The term “recording information” refers to stored data representing conversation content together with associated metadata such as timestamps and speaker identifiers.

The term “time-series information” refers to temporal information indicating the order and timing of utterances or events in a communication, such as timestamps or sequence indices.

The term “speaker identification information” refers to data that identifies which party, such as the user or the communication counterpart, produced a given utterance or message.

The term “classification model” refers to a computational model configured to assign one or more labels or scores to input data, such as determining whether an utterance is suspicious or nonsuspicious.

The term “evaluation information” refers to data indicating a result of an analysis of conversation content, including for example scores, labels, or explanations representing degrees of falsity or suspiciousness.

The term “next action” refers to an operation or behavior that a user or system is advised to perform after or during a communication, such as terminating a call, requesting verification, or reporting an incident.

The term “action proposal information” refers to information generated for presentation to a user that suggests one or more next actions in response to evaluation information or conversation context.

The term “user terminal” refers to an electronic apparatus operated by or accessible to a user, such as a smartphone, tablet, personal computer, or communication device, that sends, receives, or displays information.

The term “response guideline information” refers to stored policy data or rules that define how the system should respond to particular patterns of communications, risk levels, or detected behaviors.

The term “automatic response prompt sentence” refers to a prompt sentence constructed to cause a generative information processing model to generate automatic response information suitable for transmission to a communication counterpart, in accordance with response guideline information and evaluation information.

The term “automatic response information” refers to response information generated by the generative information processing model in accordance with an automatic response prompt sentence, which is intended to be transmitted to a communication counterpart without requiring manual composition by the user.

The term “explanation information” refers to information that describes or clarifies analysis results, including identification of which portions of utterance content are considered false or suspicious and reasons for such determination.

The term “emotion analysis processing” refers to a computational process that analyzes signals such as audio, text, or interaction data to estimate an emotional state of a user, for example stress, anxiety, or calmness.

The term “emotion state information” refers to data indicating a result of the emotion analysis processing, representing one or more emotional conditions or intensities of a user.

The term “style of a prompt sentence” refers to writing characteristics of the prompt sentence, such as formality, politeness level, or narrative structure, which influence the output of the generative information processing model.

The term “tone of a prompt sentence” refers to the attitudinal or affective quality expressed by the prompt sentence, such as urgent, reassuring, neutral, or cautious, which affects the generated output.

The term “level of detail of a prompt sentence” refers to the degree of specificity or granularity in the instructions or contextual information contained in the prompt sentence, which influences the completeness and depth of the generated output.

In one embodiment, a server cooperates with one or more terminals to implement the system described in the claims. The server comprises at least one processor, a main memory, a non-volatile storage device, and a network interface. The terminal comprises a processor, a memory, an audio input/output device, a display, and a communication interface. The processor of the server executes a communication handling program stored in the non-volatile storage device. The processor of the terminal executes an application program that communicates with the server and performs user interaction, audio acquisition, and audio or text output.

The server executes an operating system such as a general-purpose server operating system, a web server such as an HTTP server, and an application framework such as a web application framework. The terminal executes an operating system for a mobile or desktop device, and exposes an application programming interface for telephony, messaging, audio input/output, and graphical user interface.

The server stores in the non-volatile storage device a set of software modules including: a speech recognition module interface, a natural language processing module, a falsity evaluation module, a generative AI model interface, a classification model, an emotion analysis interface, a prompt sentence generation module, a response guideline storage, a conversation log manager, and a terminal communication module. The server also stores one or more trained machine learning models in a model storage, including at least one generative AI model and at least one classification model.

The terminal stores in its memory a client application that interacts with the user, detects user input such as a request to switch to artificial intelligence automatic response, records audio from a microphone, and plays back audio through a speaker. The terminal uses the operating system's telephony or messaging API to receive incoming communications and to deliver outgoing responses.

The server, in one implementation, utilizes a generative AI model in the form of a multi-layer neural network with an attention-based architecture (for example, a transformer-type language model). The generative AI model includes an input embedding layer, a stack of self-attention blocks each having query, key, and value projections and feed-forward sublayers, and an output projection layer that produces probability distributions over token vocabularies. The server stores parameters (weights) of the generative AI model in the model storage and loads these parameters into memory when the communication handling program starts.

The server trains the generative AI model on a corpus of text data including conversation data, security guidance texts, and example responses to suspicious communications. The server performs training off-line by minimizing a loss function such as a cross-entropy loss between predicted tokens and ground-truth tokens using stochastic gradient descent or a variant thereof such as Adam. The server updates the weights of the model according to backpropagation, and may employ techniques such as gradient clipping, learning rate scheduling, and data augmentation (for example, paraphrasing and synonym substitution in prompts and responses) to improve generalization.

The server uses a classification model, which can be implemented as a neural network or a gradient-boosted decision tree model, to output a risk score or falsity score for each conversation or utterance. The classification model takes as input features derived from the natural language processing module, such as term frequency-inverse document frequency vectors, contextual embeddings from the generative AI model, semantic role labels, and conversation-level features (including number of requests for credentials, number of urgency expressions, and temporal spacing of such requests). The server trains this classification model using supervised learning with labeled examples of legitimate and fraudulent communications. The server uses a loss function such as a binary cross-entropy loss and updates model parameters using gradient-based optimization.

The server uses a natural language processing module to convert raw text information into intermediate structured representations. The server applies tokenization, sentence segmentation, part-of-speech tagging, named entity recognition, dependency parsing, and semantic similarity computation. The server thereby obtains feature vectors and structured representations that are supplied to the falsity evaluation module and the classification model. This processing allows the server to capture semantic patterns and dependency structures that cannot be observed by simple keyword matching.

The server uses a speech recognition module interface to obtain text information from audio. In one embodiment, the server transmits audio data from the terminal to a remote speech recognition service. The remote service implements an acoustic model (such as a deep neural network trained on spectrogram inputs) and a language model to output text transcripts. The server receives the transcripts, checks their confidence scores, and associates them with timestamps and speaker identification information. In another embodiment, the terminal uses its local speech recognition engine to convert audio to text and sends only text to the server, reducing network bandwidth consumption.

The terminal acquires audio information from a microphone and digitizes the audio into pulse code modulation samples. The terminal then either compresses the audio using a codec and transmits the encoded audio to the server or feeds the audio into a local speech recognition engine. The terminal uses an audio input API to continuously capture audio frames during an ongoing voice communication and associates each audio frame with a session identifier so that the server can maintain a consistent conversation context.

The server uses the conversation log manager to store conversation content, including both transcripts and metadata, into structured data tables in a database system. The server stores for each utterance fields such as a session identifier, a speaker label (user, counterpart, or AI), a textual content, a timestamp or sequence index, and one or more evaluation fields such as risk score or falsity score. The server indexes the database on session identifier and timestamp to allow efficient retrieval and aggregation of conversation segments for analysis.

The server uses the falsity evaluation module to compute evaluation information from the conversation content. The server combines outputs from the classification model with rule-based checks, such as detecting the presence of patterns like requests for one-time passwords, threats demanding immediate payment, or attempts to bypass security questions. The server can represent rules as a rule set with pattern definitions, thresholds, and weights. The server computes an overall falsity score or suspiciousness score as a weighted function of the classification model output and rule-based indicators. For example, the server may compute a score S as S=w1·Pmodel+w2·Rpattern+w3·Rsequence, where Pmodel is the probability of fraud from the classification model, Rpattern is a normalized count of specific suspicious patterns, and Rsequence is a measure of suspicious temporal patterns in the conversation.

The server uses the prompt sentence generation module to construct prompt sentences provided to the generative AI model. The server maintains template data structures for different purposes, including falsity evaluation, action proposals, automatic responses, and explanation generation. Each template includes placeholders for variables such as current risk scores, extracted suspicious utterances, conversation summaries, and user emotion state information. The server fills these placeholders with current values from the conversation log and evaluation data.

In one example, the server generates a prompt sentence for an initial automatic response as follows:
“Please provide an example response to a suspicious phone call. Emphasize that you are responding as a security service.”

In another example, the server generates a prompt sentence for falsity analysis:
“Analyze the following conversation and highlight any statements that are likely to be fraudulent or deceptive. Provide a short explanation for each suspicious statement.”

In another example, the server generates a prompt sentence for an action proposal:
“Based on the following risk assessment and conversation summary, suggest the next action for the user. Consider options such as: hang up immediately, ask for additional verification, contact an official support line, or report to the police. Provide a concise recommendation.”

In yet another example, the server generates a prompt sentence for template refinement:
“Rephrase the following response so that it is polite but firm, and clearly states that no personal information will be provided: ‘We cannot provide any personal or financial information over the phone.’”

The server provides these prompt sentences, together with context data such as conversation summaries, risk scores, and user emotion state information, as textual input to the generative AI model. The generative AI model, by virtue of its learned parameters and attention-based architecture, generates output tokens that form response information or explanation information. The server decodes these tokens and assembles them into response strings.

The terminal outputs the response information by using different media depending on the communication type. If the communication is a voice call, the terminal sends the text response to a text-to-speech engine provided by the operating system. The terminal instructs the engine to synthesize the text into an audio waveform, which the telephony interface transmits to the counterpart. If the communication is a text-based chat, the terminal sends the response information as a text message or displays it in a chat window. The server thereby causes the terminal to control real hardware such as microphones, speakers, and radios in accordance with the generated response information.

The server implements emotion analysis either on the terminal-side or on the server-side. The terminal can compute prosodic features such as pitch, intensity, and speaking rate from the user's voice and can transmit these features to the server. The server can use a neural network classifier that maps a sequence of such features, optionally combined with text-based sentiment scores, to emotion state information such as “calm”, “stressed”, or “confused”. The server uses this emotion state information to adjust the style, tone, and level of detail of subsequent prompt sentences. For example, when the user is stressed, the server may generate prompt sentences that instruct the generative AI model to provide shorter, clearer, and more reassuring responses.

The server achieves a technical improvement over conventional systems by coordinating several AI and non-AI modules through specific data structures and algorithms. The server does not merely automate what a human operator would do, but introduces a structured mechanism whereby evaluation information dynamically influences prompt sentence generation, which in turn controls the behavior of the generative AI model. Because the server maintains a time-aligned conversation log and associates each generated response and evaluation with specific segments of the conversation, the server can reuse and refine context in a way that reduces redundant computation and improves accuracy. For instance, the server can cache intermediate representations (embeddings) of previous utterances and avoid recomputing them when evaluating additional segments, thereby decreasing processing latency.

The server reduces communication load by allowing the terminal to transmit text instead of raw audio when a local speech recognition engine is available, and by sending only incremental conversation segments rather than full transcripts. The server also improves overall computation efficiency by using modular architectures: the classification model processes compressed feature vectors rather than raw text; the generative AI model is invoked with compact conversation summaries, not entire logs; and the emotion analysis module receives quantitative feature vectors rather than unprocessed audio streams.

The server improves detection accuracy by using a hybrid of model-based and rule-based evaluation. The classification model captures non-linear patterns and long-range dependencies, while the rule-based system enforces explicit security policies. The combination reduces false negatives and false positives compared with pure keyword-based or single-model approaches. By precomputing risk features and using them as additional tokens or control codes in prompt sentences, the server allows the generative AI model to directly condition on quantitative risk assessments, resulting in more targeted and consistent outputs.

The server further improves the functioning of the computer system by enabling explainability. Unlike typical abstract AI applications, the server generates explanation information that pinpoints specific utterance segments judged as suspicious and the reasons derived from both rules and model outputs. The server structures this information and sends it to the terminal, which can render it in a user interface displaying aligned text, risk scores, and explanations. This structured alignment is achieved by associating token indices produced during NLP processing with database entries, allowing efficient mapping from raw transcripts to explanation segments without reprocessing the entire text.

In alternative embodiments, the server can deploy different neural network architectures for the generative AI model, such as encoder-decoder transformers or recurrent neural networks. The server can alter hyperparameters such as the number of layers, hidden dimensions, attention heads, and vocabulary size to balance accuracy and computational cost. The server can fine-tune the generative AI model for specific languages or domains by continuing training on domain-specific conversation data.

In another embodiment, the terminal can host a lightweight generative AI model locally for low-latency responses, while the server hosts a larger, more capable model for detailed analysis and explanation generation. The terminal can then select between local and remote generation based on network conditions, user preferences, or risk level. This configuration reduces round-trip latency for time-critical responses while preserving high analysis accuracy for complex cases.

In another embodiment, the server can use different types of classification models, such as support vector machines or ensembles of decision trees, depending on deployment constraints. The server can store multiple model versions and select a particular model based on device type, network conditions, or regulatory requirements. The server can also update models over time by collecting anonymized conversation logs and re-training the models to account for new fraud patterns.

The user interacts with the system by operating the terminal. The user can trigger artificial intelligence automatic response mode, view action proposal information, and choose to follow or disregard system recommendations. The user can also configure sensitivity levels or notification settings, which the server records as preference parameters and uses to adjust thresholds in the falsity evaluation module and the rule-based system.

By integrating these components into a single, coordinated architecture, the server and the terminal together form a system that not only automates communication handling but also improves the underlying computer processing of communications. The system achieves improved processing speed by reducing redundant computations, improved accuracy by combining multiple models and rule-based logic, improved data management by maintaining structured, indexed logs, and reduced communication load by optimizing data representations and transmission strategies. The system thereby provides concrete technical benefits beyond abstract data analysis, and controls actual communication hardware and software to achieve improved handling of suspicious communications in real-world environments.

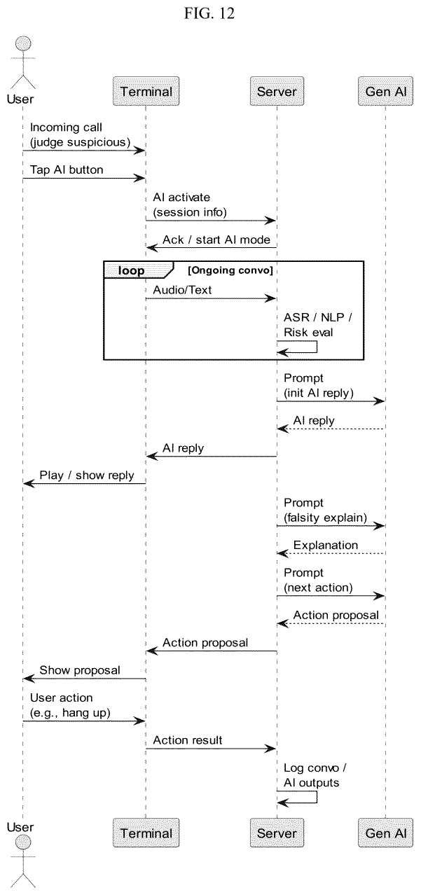

The following describes the processing flow using FIG. 12.

### Step 1:

The terminal receives an incoming communication.

The terminal uses its communication interface and operating system telephony or messaging API to accept a voice call or text message. The input is a network-level communication signal including call setup information (caller identifier, call type, signaling headers) or message data. The terminal decodes the signaling, associates the communication with a new session identifier, and outputs a session record containing the caller information, the communication type, and a reference to the active audio or messaging channel.

### Step 2:

The user evaluates whether the incoming communication appears suspicious.

The terminal displays caller information and, in the case of a voice call, outputs the initial audio to the user via the speaker. The input is the session record and any audio or text content already received. The user listens to the audio or reads the displayed text and mentally judges whether the communication is suspicious. The output is a user operation: the user either presses an “AI assist” button or does nothing. This user operation is detected by the terminal as a user interface event associated with the session.

### Step 3:

The terminal transmits an AI activation request to the server.

The terminal, in response to the user pressing the AI assist button, constructs an activation request payload. The input is the session record, including caller identifier, communication type, and timestamp, and optionally a short text snippet or partial transcript. The terminal packs these fields into a structured object (for example, a JSON object) and sends it to the server over a secure channel via HTTPS. The output is a network request containing the activation data and a unique session identifier that the server can use to track subsequent processing.

### Step 4:

The server initializes context for the session.

The server receives the activation request through its network interface and parses the received payload. The input is the activation request, including session identifier, caller identifier, communication type, and optional initial text. The server validates the session identifier, checks that the request originates from a registered terminal, and creates or updates a session context structure in memory. The server stores fields such as start time, caller identifier, communication type, and current status (“AI mode active”). The output is an initialized session context ready for further processing and stored in a session management table or cache.

### Step 5:

The terminal acquires audio and/or text from the ongoing communication.

The terminal, while the communication continues, captures audio from the microphone or collects text messages in real time. The input is the live audio stream or text stream associated with the session. The terminal segments the audio into frames or gathers text messages into linguistic units and assigns timestamps and speaker tags (for example, user or counterpart) to each segment. The output is a stream of audio segments or text segments labeled with session identifier, timestamp, and speaker role.

### Step 6:

The terminal or server converts audio to text.

The terminal either sends audio segments to the server or performs local speech recognition. The input is the sequence of audio segments tagged with session and speaker labels. If the terminal performs local recognition, the terminal feeds the audio segments into a speech recognition engine that computes acoustic features (for example, Mel-frequency cepstral coefficients), matches them to acoustic models, and decodes them into text. If the server performs recognition, the server receives audio, forwards it to a speech recognition module, and obtains transcripts. In both cases, the output is text information (recognized utterances) associated with session identifier, timestamp, and speaker label.

### Step 7:

The server logs conversation content.

The server receives text segments (recognized utterances or typed messages) from the terminal. The input is a sequence of text segments, each with session identifier, timestamp, and speaker label. The server structures each segment into a database record and stores it in a conversation log table. The server may also compute and store additional metadata, such as language code or recognition confidence. The output is a persistent conversation log for the session, indexed by session identifier and time, which can be efficiently retrieved for later analysis.

### Step 8:

The server performs preliminary natural language processing.

The server processes each new text segment using a natural language processing module. The input is a text segment and its associated metadata. The server tokenizes the text, performs sentence segmentation, assigns part-of-speech tags, and detects named entities (such as account numbers or organization names). The server may convert the text into vector representations (for example, contextual embeddings) using a language model. The output is an enriched segment representation that includes the original text, linguistic annotations, and numerical feature vectors.

### Step 9:

The server evaluates falsity and suspiciousness using models and rules.

The server aggregates enriched segment representations over a time window or the entire session. The input is a sequence of enriched segments, along with conversation-level features such as the number of credential requests or urgency phrases. The server feeds feature vectors into a classification model and also applies rule-based checks (for example, detection of specific keyword patterns and sequences). The server computes a composite risk or falsity score based on model outputs and rule indicators, for example by computing a weighted sum or other combining function. The output is evaluation information that includes at least one numerical score, labels (such as “low”, “medium”, “high” risk), and optionally which rules matched.

### Step 10:

The server generates a prompt sentence for AI-based response generation.

The server decides to generate an automatic response for the communication counterpart. The input is the latest text segment(s), the evaluation information (risk score, suspicious features), and the session context (for example, communication type). The server selects a response template and fills placeholders with current context. For example, the server may generate the following prompt sentence:
“Please provide an example response to a suspicious phone call. Emphasize that you are responding as a security service.”

The server may also append specific details, such as “The caller is asking for a bank account number and a one-time password.” The output is a complete prompt sentence (or prompt text block) tailored to the current situation.

### Step 11:

The server invokes the generative AI model to create response information.

The server sends the generated prompt sentence, and optionally a short summary of recent utterances, to a generative AI model. The input is the prompt sentence and context text. The server converts these into token sequences, feeds them into the generative AI model, and executes inference. The generative AI model computes attention over tokens and outputs probabilities over vocabulary tokens step by step. The server decodes the highest-probability tokens or uses sampling to construct a response text. The output is response information such as: “This is the security service. How can I help you today?” The server may post-process this text by trimming or enforcing policy constraints.

### Step 12:

The server transmits the AI-generated response to the terminal.

The server prepares a response message containing the generated response text and associates it with the session identifier. The input is the response text and the session context indicating the communication type (voice or text). The server serializes this into a structured payload (for example, with fields response_text and media_type), and sends it back to the terminal over HTTPS. The output is a network response that the terminal receives and parses.

### Step 13:

The terminal outputs the AI-generated response to the communication counterpart.

The terminal, upon receiving the AI-generated response payload, determines the appropriate output channel. The input is the response text and media_type flag. If the communication is a voice call, the terminal passes the text to a text-to-speech engine and generates an audio waveform. The terminal then plays this waveform into the active call channel using the telephony API. If the communication is a text message, the terminal inserts the response text into the message interface and sends it as a message. The output is the actual content (audio or text) delivered to the communication counterpart.

### Step 14:

The server generates a prompt sentence for detailed falsity explanation.

The server, after computing a risk score, constructs a prompt sentence to obtain a human-readable explanation. The input is the conversation text (or selected suspicious segments) and the evaluation information. The server builds a prompt such as:
“Analyze the following conversation and highlight any statements that are likely to be fraudulent or deceptive. Provide a short explanation for each suspicious statement.”
   The server includes the relevant transcript in the prompt. The output is a detailed prompt text that directs the generative AI model to produce structured explanation information.

### Step 15:

The server obtains explanation information from the generative AI model.

The server submits the explanation-oriented prompt sentence and transcript context to the generative AI model. The input is the prompt text and associated conversation segments. The generative AI model processes the entire input and generates explanation content such as bullet points mapping suspicious sentences to reasons. The server decodes and segments this explanation content into structured units (for example, each containing an excerpt and a rationale). The output is explanation information that the server stores in relation to the conversation log (for example, mapping explanation segments to specific utterance indices).

### Step 16:

The server generates a prompt sentence for next action recommendation.

The server constructs a prompt sentence to instruct the generative AI model to propose the next action for the user. The input is evaluation information (risk score, rule matches), a summary of conversation content, and optionally user preference parameters. The server creates a prompt such as:
“Based on the following risk assessment and conversation summary, suggest the next action for the user. Consider options such as: hang up immediately, ask for additional verification, contact an official support line, or report to the police. Provide a concise recommendation.”

The output is a next-action prompt sentence that encodes the system's evaluation and policy context.

### Step 17:

The server generates action proposal information via the generative AI model.

The server sends the next-action prompt sentence and associated context to the generative AI model. The input is the prompt text and an encoded representation of the evaluation information and summary. The generative AI model processes these inputs and outputs a short recommendation, for example: “This communication appears highly suspicious. You should end the call immediately and avoid sharing any personal or financial information.” The server receives this text, may validate its compliance with response guidelines, and packages it as action proposal information. The output is a text recommendation ready to be delivered to the user.

### Step 18:

The server notifies the action proposal information to the terminal.

The server constructs a notification payload containing the action proposal text, the risk score, and optional explanation references. The input is the action proposal information and session identifier. The server sends this payload via HTTPS to the terminal. The output is a network message that the terminal receives and associates with the corresponding ongoing communication.

### Step 19:

The terminal presents the action proposal information to the user.

The terminal parses the notification payload and updates its user interface. The input is the action proposal text, risk score, and any explanatory metadata. The terminal displays the recommendation on the screen, optionally with color coding or icons indicating the severity level, and may play a notification sound. The output is a visual and/or auditory presentation that informs the user of the recommended next action during the ongoing communication.

### Step 20:

The user decides and operates the terminal based on the proposal.

The user views or hears the action proposal information and chooses whether to accept it. The input is the displayed recommendation and the ongoing conversation context. The user may press a control such as “Hang up now” or “Request verification.” The output is a user command captured by the terminal, which is translated into a system operation (for example, terminating the call or sending a verification request message).

### Step 21:

The terminal executes the user-selected action in the communication channel.

The terminal receives the user command as a UI event and maps it to a corresponding communication operation. The input is the selected action (for example, hang up) and the session identifier. The terminal calls the telephony or messaging API to terminate the call, send a follow-up message, or perform another network action. The output is a change in the communication channel state, such as call disconnection, that directly affects the real-world communication.

### Step 22:

The server generates and sends automatic responses based on pre-stored guidelines. The server, when a high-risk condition is detected, may decide to issue automatic responses even without further user input. The input is evaluation information, conversation content, and response guideline information (policies and templates). The server selects an appropriate response template and may refine it using a prompt such as:
“Rephrase the following response so that it is polite but firm, and clearly states that no personal information will be provided: ‘We cannot provide any personal or financial information over the phone.’”

The generative AI model returns a refined response text; the server validates it and sends it to the terminal as automatic response information. The output is a ready-to-deliver response that the terminal then outputs to the communication counterpart via voice or text.

### Step 23:

The server updates logs with all generated information and outcomes.

The server records the full history of the session, including AI-generated responses, evaluation scores, explanation information, action proposals, and the actual actions taken by the user or terminal. The input is each generated or received data element (responses, scores, prompts, decisions). The server associates these with the conversation log using session identifier and timestamps, and writes them into persistent storage. The output is a comprehensive audit trail that can be used for retraining models, improving rules, and analyzing system performance with respect to detection accuracy, response latency, and user compliance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional automated response systems and conversational analysis systems suffer from several technical limitations in how they process audio communication and generate guidance for users. First, such systems typically apply speech recognition and simple keyword-based or rule-based natural language processing directly to audio-derived text, without incorporating external factual data such as time-dependent or location-dependent information from external data sources. As a result, these systems are technically unable to reliably evaluate whether a given statement in a communication is consistent or inconsistent with objective external facts, and therefore cannot accurately assess the likelihood of falsity of the statement.

Second, conventional systems generally treat text analysis, external data retrieval, and response generation as separate, loosely coupled modules. The lack of an integrated pipeline configured to (i) normalize temporal and spatial expressions in the transcribed text, (ii) automatically query external information sources based on the normalized expressions, and (iii) construct structured prompt sentences for a generative artificial intelligence model, leads to inefficient processing, higher latency, and inconsistent evaluation quality. This fragmented architecture imposes additional computational overhead and complicates scaling of the system.

Third, many existing systems are designed to output static decision rules or fixed templates, and are not configured to use generative artificial intelligence models through precisely structured prompt sentences that jointly encode: the user's statement, linguistic features extracted by natural language processing, factual data acquired from external information sources, and system-level instructions specifying evaluation and action recommendation tasks. Consequently, the systems cannot fully leverage generative models to perform nuanced falsity evaluation and adaptive action recommendation in a technically efficient and consistent manner.

Fourth, conventional systems typically do not integrate emotion analysis with falsity evaluation in a coordinated processing pipeline. Emotion analysis, when present, is often used only for reporting, and does not dynamically influence the content or style of prompt sentences or subsequent generated guidance. This limitation results in system outputs that may be technically correct at a factual level but suboptimal in terms of user understanding, user trust, and interaction effectiveness.

Moreover, existing systems for switching between human-based and automated responses in live communications usually trigger a simple mode change without tightly coupling the switch to the subsequent end-to-end processing of audio, external fact retrieval, falsity evaluation, and action proposal. This design fails to exploit potential computational optimizations and reduces the system's capability to provide low-latency, context-aware assistance during an ongoing communication.

Accordingly, there is a need for an improved computer-implemented system and method that technically enhance the way a processor handles received communication, including (i) switching from human to automatic response, (ii) capturing and transcribing audio, (iii) performing structured linguistic analysis, (iv) retrieving relevant external factual information, (v) constructing prompt sentences for a generative artificial intelligence model in a systematic and repeatable manner, (vi) evaluating falsity of statements based on the combined information, (vii) generating contextually appropriate action proposals, and (viii) optionally adjusting such evaluations and proposals based on emotion analysis. Such improvements should provide a more efficient, accurate, and scalable computer architecture for automated communication analysis and guidance generation, thereby improving the functioning of the computer system itself rather than merely automating a human mental process.

The specific processing by the specific processing unit 290 of the data processing device 12 in Example 2 is realized by the following means.

The present invention provides a server comprising a processor, the processor being configured to switch handling of received communication from a human response to an automatic response process, to acquire audio information from an acoustic input unit of a terminal as digital audio information, to convert the digital audio information into character information by using a speech recognition technique, to apply a natural language processing technique to the character information to extract syntactic information and semantic information, to normalize time expressions and location expressions included in the character information, to acquire factual information from an external information source on the basis of the normalized time expressions and location expressions, to generate input information to be input to a generative information processing model by generating a prompt sentence including an evaluation instruction sentence for evaluating falsity of a statement on the basis of the character information, the factual information, and at least one of the syntactic information and the semantic information, to obtain analysis information from the generative information processing model and determine the falsity of the statement on the basis of the analysis information, to record the character information, the factual information, and a determination result of the falsity in association with each other in a storage device, and to transmit the determination result of the falsity to the terminal and output the determination result as display information, the processor optionally being further configured to generate a prompt sentence including an action proposal instruction sentence for presenting candidate actions to be next executed by a user on the basis of the determination result of the falsity and the factual information, to obtain response information relating to the candidate actions from the generative information processing model so as to generate action proposal information, and to apply emotion analysis processing to the character information to generate emotion information indicating an emotional state of the user and adjust contents of at least one of the evaluation instruction sentence and the action proposal instruction sentence on the basis of the emotion information and the determination result of the falsity. This enables an integrated and technically improved processing pipeline in which the server automatically coordinates communication switching, audio acquisition, speech recognition, structured natural language processing, external factual data retrieval, prompt sentence construction for a generative artificial intelligence model, falsity evaluation, and adaptive action proposal, thereby improving accuracy and consistency of falsity assessment, reducing computational overhead and latency for end-to-end processing, and enhancing the overall functioning and technical performance of the computer system in automated communication analysis and guidance generation.

The term “processor” refers to a hardware computation unit or a combination of hardware computation units configured to execute machine-readable instructions, including but not limited to a central processing unit, a graphics processing unit, a digital signal processor, or any combination thereof.

The term “terminal” refers to an electronic device operated by a user and configured to capture audio, display information, and communicate with a server over a communication network, including but not limited to a smartphone, a tablet, a personal computer, or a dedicated communication device.

The term “acoustic input unit” refers to a hardware component or assembly of hardware components in the terminal configured to capture sound and convert the sound into an electrical or digital signal, including but not limited to a microphone and associated audio interface circuitry.

The term “audio information” refers to data representing sound, including voice, captured by the acoustic input unit, in either analog form or digital form before further processing.

The term “digital audio information” refers to audio information that has been converted into a digital representation composed of discrete numerical values, such as pulse code modulation samples or compressed audio frames, suitable for processing by the processor.

The term “character information” refers to text data obtained from digital audio information by speech recognition processing, including sequences of characters, symbols, or tokens representing words or phrases spoken by a user.

The term “speech recognition technique” refers to a computational method or algorithm configured to convert digital audio information into character information, including but not limited to acoustic modeling, language modeling, and decoding processes implemented by software or hardware.

The term “natural language processing technique” refers to a computational method or algorithm configured to analyze character information to derive linguistic structure or meaning, including but not limited to tokenization, part-of-speech tagging, syntactic parsing, semantic analysis, and named entity recognition.

The term “syntactic information” refers to information indicating grammatical structure of character information, including but not limited to parts of speech, dependency relations, phrase boundaries, and clause boundaries.

The term “semantic information” refers to information indicating meaning or interpretation of character information, including but not limited to detected entities, concepts, relations, intents, and logical propositions.

The term “time expression” refers to a portion of character information that denotes a temporal concept, including but not limited to explicit dates, times, and relative temporal references such as “yesterday,” “last week,” or “next month.”

The term “location expression” refers to a portion of character information that denotes a spatial or geographical concept, including but not limited to place names, addresses, regions, coordinates, or other indicators of position.

The term “normalize time expressions and location expressions” refers to processing time expressions and location expressions contained in character information to convert the expressions into standardized representations, such as specific calendar dates, time intervals, or geographic coordinates, that can be used for programmatic querying of external information sources.

The term “external information source” refers to a system, service, database, or data store separate from the server, accessible via a communication network, and configured to provide factual information, including but not limited to environmental data services, public records databases, or business information services.

The term “factual information” refers to data obtained from an external information source that represents objective or recorded facts, such as environmental conditions, event records, or other verifiable information, which can be compared with the content of character information.

The term “generative information processing model” refers to a machine learning model or artificial intelligence model configured to generate text or other structured output based on an input sequence, including but not limited to a neural network-based language model.

The term “prompt sentence” refers to a sequence of one or more natural-language statements or instructions constructed by the processor and provided as input to a generative information processing model to specify a task, context, or constraints for generation of output.

The term “evaluation instruction sentence” refers to a portion of a prompt sentence that explicitly instructs the generative information processing model to evaluate a property of a statement, including but not limited to the likelihood of falsity, consistency with facts, or degree of confidence.

The term “action proposal instruction sentence” refers to a portion of a prompt sentence that explicitly instructs the generative information processing model to propose one or more actions or action candidates to be taken by a user or system, based on evaluation results or factual information.

The term “input information” refers to data generated by the processor and provided to a generative information processing model, including at least one prompt sentence and optionally additional structured context, to cause the generative information processing model to generate analysis information or proposal information.

The term “analysis information” refers to output data generated by the generative information processing model in response to input information, including but not limited to explanations, classifications, likelihood assessments, or other evaluative content relating to a statement.

The term “falsity of a statement” refers to an assessment of whether content expressed in character information is inconsistent with factual information or is otherwise likely to be untrue, including but not limited to binary decisions or probabilistic evaluations.

The term “determination result of the falsity” refers to data representing an outcome of processing performed by the processor to decide or estimate the falsity of a statement on the basis of analysis information, factual information, or other derived information.

The term “storage device” refers to a hardware component or combination of hardware components configured to store data in a non-transitory manner, including but not limited to a magnetic disk, a solid-state drive, a semiconductor memory, or a network-attached storage system.

The term “action proposal information” refers to data indicating one or more proposed actions to be taken by a user or by a system, generated on the basis of response information from the generative information processing model, the determination result of the falsity, and factual information.

The term “response information” refers to output data generated by the generative information processing model in response to a prompt sentence including an action proposal instruction sentence, the output data including proposed actions or guidance regarding potential actions.

The term “emotion analysis processing” refers to a computational method or algorithm configured to analyze character information or related communication data to infer an emotional state, sentiment, or affective attribute associated with a user or an utterance.

The term “emotion information” refers to data representing an inferred emotional state or sentiment of a user, including but not limited to categories such as positive, negative, neutral, or more fine-grained emotional labels and associated confidence values.

The term “display information” refers to data formatted or structured for presentation on a display unit of a terminal, including but not limited to text, icons, indicators, or graphical elements representing the determination result of the falsity, action proposals, or explanations.

The term “automatic response process” refers to processing performed by the server or another computing system to generate or manage responses to received communication without direct human intervention, using automated analysis, decision, and generation functions.

The term “received communication” refers to any incoming interaction or message received by the system, including but not limited to voice calls, voice messages, or other audio-based communications that can be processed by the server.

In one embodiment, a server cooperates with a terminal operated by a user to perform integrated processing of audio communication, linguistic analysis, factual consistency evaluation, and action proposal generation. The server is implemented by one or more processors, a main memory, a non-volatile storage device, and a network interface. The terminal is implemented by a processor, a memory, a display unit, an acoustic input unit such as a microphone, and a wireless or wired communication interface.

The server executes an operating system such as a general-purpose server operating system and runs application software that implements a speech processing module, a natural language processing module, an external information acquisition module, a generative AI interface module, an evaluation and decision module, a data management module, and a display control module. The terminal executes an operating system such as a mobile device operating system and runs an application program that provides a user interface, audio capture functionality, communication with the server, and display of evaluation results.

The terminal uses an audio capture library, such as an audio recording application programming interface provided by the operating system, to configure an audio sampling rate, an encoding format such as 16-bit linear pulse code modulation, and a channel configuration such as monaural input. The terminal converts analog speech from the user into digital audio samples through an audio codec and stores the samples in a buffer in the memory. The terminal manages the buffer as a specific data structure containing a sequence of fixed-size audio frames, each frame including a timestamp and a sequence number. This framing enables the server to process audio segments in a streaming manner, which reduces latency and improves throughput.

The terminal transmits the digital audio information to the server using a communication protocol such as Hypertext Transfer Protocol Secure. The terminal embeds the audio frames in a request body and includes metadata such as a user identifier, a session identifier, a language code, and a terminal type. The server receives the digital audio information through the network interface and writes the frames to a temporary storage area in the non-volatile storage device, maintaining an index structure that associates audio frame offsets with session identifiers. This indexed storage allows the server to re-access specific segments for reprocessing or auditing, which is advantageous for error analysis and model retraining.

The server uses a speech recognition engine, which can be implemented by a statistical acoustic model and a language model or by a neural network model trained on large-scale speech data, to convert digital audio information into character information. The server may employ a model that takes as input a sequence of acoustic feature vectors, such as mel-frequency cepstral coefficients, and outputs a probability distribution over phonetic units or graphemes for each time frame. The server then performs decoding using a beam search algorithm with a lexicon and a language model to obtain the most likely sequence of words. The server stores the recognized text as character information together with a confidence score and timestamps for individual words in a structured record in the storage device. The server applies a natural language processing technique to the character information. In one embodiment, the server uses an NLP library such as a dependency parser to tokenize the text, assign part-of-speech tags, identify syntactic dependencies, and recognize named entities. The server represents the processed text as a graph-like data structure, in which nodes correspond to tokens and edges correspond to dependency relations. The server further annotates nodes with attributes such as lemma, part-of-speech, named entity type, and position. This explicit graph structure enables efficient traversal when extracting time expressions and location expressions and when constructing normalized representations. The server identifies time expressions such as “yesterday” or “last Friday” and converts them into concrete calendar dates by using the recording timestamp stored in the session metadata. The server also identifies location expressions such as city names or regions and resolves them to standardized identifiers such as geographical coordinates or region codes. The server maintains a normalization table that maps relative expressions to absolute time ranges and that maps location names to coordinates based on a gazetteer or a location database. The normalized time and location information form part of a factual query structure used by the external information acquisition module.

The server uses the external information acquisition module to access an external information source via a network interface. In one embodiment, the server sends a structured query specifying a time interval and a location coordinate to an external service that provides factual data such as environmental measurements. The external service returns factual information in a machine-readable format such as a sequence of records indicating event times and corresponding measurements. The server maps this factual information into a normalized internal data structure, aligning time intervals with the time expressions in the character information. By standardizing both the text-derived information and the external factual information, the server can perform algorithmic comparison operations to identify inconsistencies.

The server constructs a prompt sentence for a generative AI model. In one embodiment, the generative AI model is a neural network-based language model including an embedding layer, multiple transformer blocks with multi-head self-attention, feed-forward networks, layer normalization, and an output layer that produces a probability distribution over tokens. The server creates an input token sequence that includes: (i) instruction text specifying an evaluation task, (ii) the user's statement as obtained from the character information, (iii) normalized factual information including time, location, and objective measurements, and (iv) explicit questions requesting classification and explanation. The server concatenates these components in a predefined order and inserts special delimiter tokens to indicate boundaries between instruction, context, and question segments. This structured layout of the token sequence is part of a non-conventional data formatting approach that improves the stability and reproducibility of the model's output.

An example of the prompt sentence used by the server is as follows:
“You are an AI system that evaluates whether a statement is likely to be false based on factual data.
Statement: “It did not rain yesterday.”
Date: 2024 Jan. 15
Location: Tokyo, Japan
Observed weather from an official data source: heavy rain during most of the day.
Tasks:
1. Evaluate the likelihood that the statement is false.
2. Explain your reasoning step by step.
3. Classify the statement into: very likely true/possibly true/possibly false/very likely false.
4. Propose the next action the user should take.
Respond in English.”

The server provides the prompt sentence as part of the input information to the generative AI model. The generative AI model internally processes the tokenized prompt sequence by applying self-attention operations that compute attention weights between tokens, allowing the model to relate parts of the statement to parts of the factual data and to the instruction sentences. The model uses learned weight matrices in the attention layers and feed-forward layers, which have been trained on a large corpus of text using a loss function such as cross-entropy between predicted tokens and ground-truth tokens. The training process uses gradient-based optimization, such as stochastic gradient descent or Adam, to update the weights, and may include data augmentation techniques like random masking of tokens to improve generalization.

The server receives analysis information from the generative AI model, including an explicit classification of the falsity likelihood, a textual explanation, and a recommended next action. The server applies parsing rules to the analysis information to extract key fields. For example, the server may use pattern matching to extract a label such as “very likely false” and to separate the explanation into individual reasoning steps. The server then stores the character information, the normalized factual information, and the determination result of falsity in a relational database. The server uses a schema with tables for sessions, utterances, factual queries, and evaluation results, and establishes foreign key relationships between these tables. This structured storage enables efficient retrieval of past evaluations and supports auditability and later model improvement.

The server can generate a separate prompt sentence including an action proposal instruction sentence. In one embodiment, the server takes as inputs the determination result of falsity, the factual information, and user-specific parameters such as prior history or risk tolerance. The server constructs an action-oriented prompt, such as:
“You are an assistant that proposes concrete next actions based on an evaluation of a statement.
Statement: “It did not rain yesterday.”
Falsity evaluation: very likely false.
Factual data: heavy rain recorded on 2024 Jan. 15 in Tokyo, Japan.
Task:
Propose three specific actions that the user should consider taking in response to this likely false statement. For each action, provide a short justification.”

The server provides this prompt to the generative AI model and obtains response information that describes possible actions. The server converts this information into action proposal information, which is stored and later transmitted to the terminal. The server associates each proposed action with a machine-parsable identifier and textual description so that the terminal can display actions as selectable options.

The server further applies emotion analysis processing to the character information. In one embodiment, the server uses a separate classification model, such as a neural network trained on text labeled with emotional categories, to predict emotion information such as anger, fear, or calmness. The emotion model may use a recurrent neural network or transformer architecture with an embedding layer and a softmax output layer. The server uses cross-entropy loss during training and updates the model by backpropagation. The server uses the predicted emotion information to adjust the content or tone of prompt sentences. For example, if the user's emotional state is classified as highly negative, the server modifies the evaluation instruction sentence or action proposal instruction sentence to adopt a more cautious or explanatory style, which can improve user comprehension and reduce misunderstanding.

The server, by combining syntactic and semantic features, normalized factual data, and emotion information in the prompt sentence construction process, implements a non-conventional rule set that determines which fields are included, how they are ordered, and which constraints are specified to the generative AI model. This rule set differs from simple template-based generation used in conventional systems because the rule set dynamically adjusts prompt content according to the falsity determination, external data confidence, and inferred emotion. As a result, the server reduces ambiguity in model inputs and improves the determinism and accuracy of generated outputs.

The terminal receives evaluation and action proposal information from the server and displays it to the user. The terminal shows the recognized text, the falsity classification, the explanatory reasoning, and the list of proposed actions on the display unit. The terminal may highlight contradictions between the user's statement and factual information, for example, by showing “User statement: It did not rain yesterday” alongside “Recorded condition: Heavy rain on 2024 Jan. 15.” The terminal can present buttons or menu entries corresponding to proposed actions, such as “Flag as suspicious,” “Request documented evidence,” or “Ignore.” When the user selects an action, the terminal transmits the selection to the server for recording and possible further processing.

The system provides technical improvements over conventional architectures. The combination of structured text graphs, normalized factual information, and carefully constructed prompt sentences reduces the need for repeated parsing and re-evaluation and allows the server to reuse precomputed intermediate representations across multiple model calls. The explicit indexing and normalization of time and location expressions lead to more precise and faster queries to external information sources, reducing network load and processing time. The integrated pipeline allows the server to execute fewer redundant operations, thus improving computational efficiency and reducing latency in falsity evaluation and action proposal generation. By storing linked records of character information, factual information, and falsity determinations, the system also improves data management, enabling efficient batch re-analysis when models are updated.

The server uses the generative AI model in a way that goes beyond mere automation of human mental judgment. The server shapes the model's input by enforcing a specific token structure, applies deterministic parsing of the model's output into machine-readable fields, and integrates this with external data retrieval and emotion analysis, resulting in a new technical workflow that modifies the behavior of the underlying computing system. By using specialized data structures and a coordinated pipeline, the server achieves improved accuracy and reduced variance in falsity assessments compared to human-only workflows or naive model invocations, and provides predictable performance under high communication loads. In alternative embodiments, the server may use different types of generative models, such as encoder-decoder architectures, or may run a locally hosted neural network instead of accessing a remote service. The external information source may provide types of factual information other than environmental data, such as event logs, transaction records, or sensor measurements. The emotion analysis processing may use multimodal input combining text with acoustic features extracted from digital audio information. The terminal may be a desktop computer, a hands-free device in a vehicle, or an embedded terminal in a communication appliance. In each case, the server, the terminal, and the user interact through the same fundamental architecture: audio is captured and transmitted, text is recognized, structural and semantic features are extracted, factual data are retrieved and normalized, prompt sentences are constructed according to a defined rule set and provided to a generative

AI model, and the resulting analysis and action proposals are presented to the user in a technically optimized manner.

Through these configurations and variations, the system improves the functioning of computer-based communication analysis by reducing processing time, lowering error rates in falsity assessment, and enabling more efficient management of large volumes of communication data, while maintaining a clear causal relationship between the specific technical features and the resulting performance benefits.

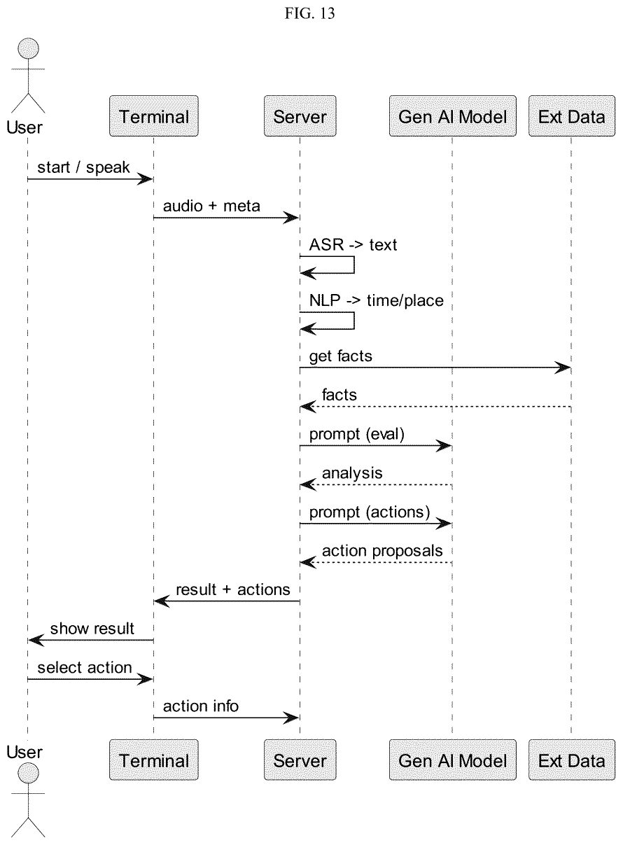

The following describes the processing flow using FIG. 13.

### Step 1:

The user operates the terminal to start audio capture.

The user taps a “Start Recording” button on the terminal screen. The terminal receives a touch event as input and calls an audio initialization routine. The terminal configures the acoustic input unit with a sampling rate, bit depth, and channel mode, and allocates a circular buffer in memory for incoming samples. The input to this step is a user interaction event; the output is an initialized audio capture context ready to receive audio samples.

### Step 2:

The terminal captures digital audio information from the user.

The user speaks into the terminal's microphone. The acoustic input unit converts analog speech into an electrical signal, and the terminal's audio codec converts the signal into digital audio samples. The terminal periodically reads blocks of samples from the audio driver into the circular buffer and segments them into fixed-length audio frames, each annotated with a local timestamp and frame index. The input is an analog voice signal from the user; the output is a sequence of time-stamped digital audio frames stored in the terminal's memory.

### Step 3:

The terminal transmits the digital audio information to the server.

The terminal constructs a network request containing the audio frames and metadata such as user identifier, session identifier, language code, and recording start time. The terminal serializes the audio frames into a binary payload and embeds the metadata into a header or a structured body. The terminal sends the request to the server over a secure communication channel. The input is the buffered digital audio frames and associated metadata; the output is a transmitted request received by the server's network interface.

### Step 4:

The server receives and stores the digital audio information.

The server accepts the incoming request via a network interface and parses the request to extract the audio payload and metadata. The server writes the audio payload to a temporary storage area and creates an index record that maps the session identifier and frame indices to byte offsets in the stored file. The input is the network request containing audio frames and metadata; the output is a stored audio file or stream with an index structure that supports subsequent retrieval of the audio segments.

### Step 5:

The server converts the digital audio information into character information using a speech recognition technique.

The server loads the stored audio segments and computes acoustic feature vectors such as mel-frequency cepstral coefficients from the raw samples. The server feeds the feature vectors into a speech recognition model that outputs probability distributions over phonetic units or subword tokens. The server applies a decoding algorithm, such as beam search with a language model, to generate the most likely word sequence. The input is the sequence of audio frames with timestamps; the output is character information consisting of recognized text, per-word timestamps, and confidence scores.

### Step 6:

The server performs natural language processing on the character information.

The server tokenizes the character information into word tokens and punctuation, assigns part-of-speech tags to each token, and computes syntactic dependency relations to form a dependency tree. The server then performs semantic analysis to detect named entities, time expressions, and location expressions. The input is the character information produced by the speech recognition model; the output is a structured linguistic representation including a token list, a dependency graph, and annotations for semantic entities.

### Step 7:

The server normalizes time expressions and location expressions.

The server examines tokens labeled as time expressions and converts relative references such as “yesterday” or “last Friday” into absolute calendar dates by adding or subtracting intervals from the recording timestamp. The server examines tokens labeled as location expressions and resolves them to standardized geographic identifiers, such as coordinates or region codes, using a location database. The input is the annotated linguistic representation with raw time and location expressions and the session metadata; the output is a set of normalized time intervals and location identifiers associated with the original text.

### Step 8:

The server acquires factual information from an external information source.

The server constructs a query containing the normalized time interval and location identifier and sends the query to an external information source over a network. The external source returns factual records, for example, measurements or events that occurred during the specified time interval at the specified location. The server parses the returned data and maps it into an internal data structure keyed by time and location. The input is the normalized time and location information; the output is factual information aligned with the statement context, such as recorded conditions or events.

### Step 9:

The server constructs a prompt sentence for a generative AI model to evaluate falsity.

The server aggregates the character information, the normalized factual information, and the extracted syntactic and semantic features. The server then assembles these elements into a prompt sentence that includes: (i) instructions for evaluation, (ii) the user's statement, (iii) a description of the factual information, and (iv) questions specifying required outputs such as classification and explanation. The input is the processed text, the factual information, and linguistic annotations; the output is a structured prompt sentence that encodes an evaluation instruction for the generative AI model.

### Step 10:

The server submits the prompt sentence to the generative AI model and obtains analysis information.

The server tokenizes the prompt sentence, converts tokens into vector embeddings, and feeds the embeddings into a generative AI model, such as a transformer-based language model, through a model interface module. The model processes the token sequence through multiple self-attention and feed-forward layers and generates a sequence of output tokens representing analysis information, including falsity assessment, reasoning, and possibly classification labels. The input is the prompt sentence constructed by the server; the output is analysis information in natural language and/or structured segments produced by the generative AI model.

### Step 11:

The server determines the falsity of the statement based on the analysis information.

The server parses the analysis information to extract an explicit falsity classification and, if present, numerical indicators such as probability or confidence. The server may apply deterministic parsing rules or pattern matching to locate labels like “very likely false” or “possibly true” within the generated text. The server then creates a determination record that encodes the falsity classification, associated scores, and relevant excerpted reasoning. The input is the analysis information output by the generative AI model; the output is a determination result of the falsity represented as a structured record.

### Step 12:

The server generates an action-oriented prompt sentence and obtains action proposal information.

The server uses the determination result of falsity and the factual information to create a second prompt sentence that instructs the generative AI model to propose specific next actions. The server includes the classification (for example, “very likely false”), a summary of the factual discrepancies, and explicit instructions to output several concrete actions with justifications. The server passes this action-oriented prompt sentence to the generative AI model, receives response information describing candidate actions, and extracts individual action proposals into structured entries. The input is the falsity determination, factual information, and previous reasoning; the output is action proposal information describing candidate actions and their rationales.

### Step 13:

The server performs emotion analysis based on the character information and optionally the audio.

The server feeds the character information, and optionally acoustic features such as pitch and energy, into an emotion classification model. The model computes feature representations and outputs an emotional label and associated confidence scores. The server stores the emotion information and uses it to adjust subsequent prompt sentences, for example by softening wording or adding explanatory detail when high negative emotion is detected. The input is the recognized text and optional audio-derived features; the output is emotion information indicating an inferred emotional state of the user.

### Step 14:

The server adjusts prompt sentences and outputs based on emotion information.

The server modifies templates or rule-based components used to construct prompt sentences so that evaluation and action proposal instructions are adapted to the user's emotional state. For example, the server may insert additional reassurance phrases or request more context instead of directly accusing falsity when strong negative emotion is present. The input is the emotion information and the previously constructed prompt templates; the output is adjusted prompt sentences and refined guidance text that reflect both factual evaluation and emotional context.

### Step 15:

The server records evaluation-related data in a storage device.

The server creates linked records that associate the character information, the normalized factual information, the determination result of falsity, the action proposal information, and the emotion information. The server writes these records into relational tables or other persistent data structures, storing foreign keys that link utterances to evaluations and external data queries. The input is the set of structured objects produced in previous steps; the output is a persistent, queryable dataset that supports later retrieval, auditing, and system improvement.

### Step 16:

The server transmits the determination result and action proposals to the terminal.

The server packages the falsity determination, explanation, and action proposal information into a structured response message and sends it to the terminal over the communication network. The server may compress or otherwise optimize the response to reduce bandwidth. The input is the structured evaluation and proposal data stored in memory; the output is a network response message delivered to the terminal.

### Step 17:

The terminal displays the evaluation results and proposed actions to the user.

The terminal receives the response message from the server, parses the contained data, and updates its user interface components. The terminal shows the recognized statement, the falsity classification, a summary of the reasoning, and a list of candidate actions as selectable elements. The input is the server's response message; the output is a visual presentation on the display unit that allows the user to understand the evaluation and select a desired follow-up action.

### Step 18:

The user selects and executes a follow-up action through the terminal.

The user reviews the displayed information and chooses one of the proposed actions, such as flagging the communication, requesting additional documentation, or ignoring the warning. The terminal receives the selection event, creates an action execution request, and sends it to the server. The input is the user's selection on the terminal interface; the output is an action execution request that allows the server to log the decision or perform further automated processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional communication support systems that attempt to detect deceit or unreliable statements typically apply fixed rule sets or static classifiers to text data after a conversation is completed. Such systems suffer from multiple technical limitations in a real-time networked environment. First, conventional architectures do not dynamically generate structured prompt sentences optimized for a generative AI model based on live conversation context, so the evaluation of falsity or reliability is often inaccurate, unstable, and difficult to scale across diverse domains. Second, existing systems generally decouple reliability assessment from user emotion estimation; as a result, the system cannot algorithmically modulate risk assessment and action recommendations according to the user's real-time emotional state, leading to inappropriate alert thresholds and either excessive false alarms or missed high-risk situations. Third, conventional solutions typically present static warnings or generic messages to user terminals without leveraging iterative prompt optimization or feedback from user behavior, so the quality of prompts, model outputs, and suggested actions does not improve over time and remains sub-optimal for the deployed generative AI model.

From the viewpoint of computer technology, these limitations manifest as inefficient and non-adaptive orchestration of multiple machine learning components (speech recognition, natural language processing, generative AI model, emotion analysis) on a server. The server processes unstructured text and audio streams in a fragmented manner, lacks a unified data model for conversation history, and has no dedicated mechanism for generating and refining task-specific prompt sentences. Consequently, system resources are not effectively utilized, latency can increase due to redundant or poorly formed model calls, and the output quality of the generative AI model is not systematically controlled. There is therefore a need for a computer-implemented technique that, within a single server-side processing pipeline, (i) structures conversation data, (ii) generates and refines prompt sentences to drive a generative AI model for falsity evaluation, (iii) integrates emotion analysis into risk and urgency computation, and (iv) generates adaptive action proposals, all while improving the overall performance, reliability, and safety of the AI-assisted communication support system.

The specific processing by the specific processing unit 290 of the data processing device 12 in Application Example 2 is realized by the following means.

The present invention provides a server comprising a processor configured to switch handling of received communication from a human operator to an automatic response process, to acquire audio information and convert the audio information into character information by using a speech recognition process, to store the converted character information and manage the character information as conversation history, to convert utterance content included in the conversation history into structured information by using a natural language processing process, to generate a first prompt sentence including the structured information and evaluation target utterance content so as to cause a generative information processing model to evaluate falsity or reliability of the utterance content, and to input the first prompt sentence to the generative information processing model to obtain an evaluation result relating to the falsity or the reliability, to execute an emotion analysis process to estimate an emotional state of a user from an audio response or a character response of the user and obtain emotion information, to determine a degree of risk and a degree of urgency based on the evaluation result and the emotion information and generate presentation information including warning information or action instruction information, and to transmit the presentation information to a terminal device so that the presentation information is presented to the user via a display device or an audio output device of the terminal device, and is further configured to generate, based on the evaluation result and the emotion information, an additional prompt sentence for instructing the generative information processing model to generate candidate actions to be executed, to input the additional prompt sentence to the generative information processing model to obtain candidate action information for proposing a next action, and to update wording of the first prompt sentence and the additional prompt sentence based on past evaluation results from the generative information processing model and on an action selection history by the user so that a prompt sentence generation process is adaptively changed. This enables the server to implement an integrated, computer-centric pipeline that structures streaming communication data, drives a generative AI model with optimized prompt sentences, fuses falsity evaluation with emotion-aware risk computation, and adaptively refines action proposals based on feedback, thereby improving technical performance of the AI-assisted communication system in terms of evaluation accuracy, latency, stability of model outputs, and appropriateness of automated guidance presented to the user.

The term “processor” refers to an information processing circuitry or computing unit, including one or more hardware processors or processing cores, configured to execute instructions for performing the functions described in the present disclosure.

The term “received communication” refers to information transmitted from an external source and input to the system, including at least audio signals, text messages, or other digital communication data.

The term “human operator” refers to a human user who would otherwise manually handle or respond to the received communication in the absence of the automatic response process.

The term “automatic response process” refers to a computer-implemented procedure by which the system, instead of the human operator, automatically analyzes the received communication and generates responses or internal evaluations.

The term “audio information” refers to data representing sound, including a voice of a caller, a voice of a user, or other acoustic signals encoded in an analog or digital format.

The term “speech recognition process” refers to a computer-implemented algorithm that converts audio information into character information by analyzing acoustic features and mapping them to textual symbols.

The term “character information” refers to digital data representing textual content, such as letters, numerals, symbols, or other character sequences obtained from the audio information.

The term “conversation history” refers to stored character information representing a sequence of utterances exchanged between parties over time, together with associated metadata for later analysis.

The term “utterance content” refers to the semantic content of a spoken or written segment within the conversation history, typically corresponding to a sentence, phrase, or turn in the dialogue.

The term “structured information” refers to data representing the utterance content in a machine-interpretable format, such as key-value pairs, labeled entities, syntactic relations, or other organized data structures suitable for further processing.

The term “natural language processing process” refers to a computer-implemented technique that analyzes character information to perform one or more tasks such as tokenization, part-of-speech tagging, syntactic parsing, semantic analysis, or entity extraction.

The term “evaluation target utterance content” refers to specific utterance content selected from the conversation history as a subject to be evaluated for falsity or reliability by the generative information processing model.

The term “prompt sentence” refers to an instruction text or query text generated by the processor and supplied to a generative information processing model to cause the model to perform a designated task, such as evaluating falsity or proposing actions.

The term “evaluation instruction sentence” refers to a particular type of prompt sentence that describes an evaluation task, including at least the structured information and the evaluation target utterance content, and instructs the generative information processing model to output an evaluation result.

The term “generative information processing model” refers to a machine learning model, including a generative AI model, that receives a prompt sentence as input and generates output information such as textual responses, evaluation scores, or proposed actions.

The term “evaluation result” refers to information output by the generative information processing model in response to the evaluation instruction sentence, including at least an indication of falsity or reliability of the evaluation target utterance content and optionally an accompanying explanation.

The term “falsity” refers to a degree or likelihood that a given utterance content does not correspond to factual information or is otherwise misleading.

The term “reliability” refers to a degree or likelihood that a given utterance content corresponds to factual information or can be trusted for decision making.

The term “emotion analysis process” refers to a computer-implemented procedure that estimates an emotional state of a user by analyzing audio information, character information, or both, and outputs emotion information.

The term “emotional state” refers to a psychological condition of the user, including states such as fear, anxiety, anger, sadness, calmness, or confidence, as inferred from communication behavior.

The term “emotion information” refers to data representing the estimated emotional state of the user, which may include one or more emotion categories and corresponding confidence values or scores.

The term “degree of risk” refers to a quantitative or qualitative measure indicating how likely the communication scenario is to be harmful, fraudulent, or otherwise detrimental to the user.

The term “degree of urgency” refers to a quantitative or qualitative measure indicating how quickly the user should respond to the communication scenario or perform a recommended action.

The term “presentation information” refers to information generated by the processor for output to the user, including at least warning information or action instruction information, and optionally additional explanatory content.

The term “warning information” refers to content that notifies the user of a potential risk, falsity, or unreliability associated with the communication, and advises caution.

The term “action instruction information” refers to content that suggests or recommends one or more specific actions for the user to take in response to the evaluated communication.

The term “terminal device” refers to an end-user electronic apparatus, such as a communication device or computing device, configured to send communication data to the server and to present presentation information to the user.

The term “display device” refers to a visual output component of the terminal device, such as a screen or monitor, configured to present characters, graphics, or other visual content to the user.

The term “audio output device” refers to an auditory output component of the terminal device, such as a speaker or earphone, configured to output sound corresponding to the presentation information.

The term “candidate actions” refers to one or more possible actions that the user may take in response to the evaluated communication, as generated by the generative information processing model.

The term “candidate action information” refers to data representing the candidate actions, including textual descriptions of the actions and optionally associated priorities or categories.

The term “refusal of payment” refers to an action in which the user does not perform a requested payment or transfer of value that is suggested or demanded in the communication.

The term “inquiry to a third party” refers to an action in which the user seeks confirmation or advice from an independent entity, such as a trusted person or organization, regarding the content of the communication.

The term “notification to a supervisory organization” refers to an action in which the user or the system informs an oversight body, regulatory body, or similar authority about a potentially fraudulent or harmful communication.

The term “notification to a trusted contact” refers to an action in which the user or the system informs a pre-registered or otherwise trusted person or entity about the communication and its associated risk.

The term “action selection history” refers to historical data representing which candidate actions were selected, accepted, or rejected by the user in past communication sessions.

The term “prompt sentence generation process” refers to a series of computational steps executed by the processor to construct, modify, and output prompt sentences for input to the generative information processing model.

The term “wording of the prompt sentence” refers to the specific linguistic expression, including choice of words, phrases, and sentence structure, used in the prompt sentence supplied to the generative information processing model.

The term “adaptively changed” refers to a characteristic of the prompt sentence generation process in which parameters, templates, or wording are automatically modified over time based on past evaluation results, user behavior, or other feedback, so as to improve system performance.

In one embodiment, a server implements the claimed system as a network-connected computing device equipped with at least one processor, a memory, a non-volatile storage device, a network interface, and optionally a hardware accelerator such as a graphics processing unit. The server executes a set of software modules including an operating system, a web service framework, a speech recognition client, a natural language processing engine, a generative AI model inference engine, an emotion analysis engine, a database management system, and an application-specific control module that coordinates prompt sentence generation, model invocation, and presentation information generation.

A terminal implements a user-facing device, such as a smartphone, tablet, or dedicated communication device, having a processor, a memory, a microphone, a speaker, a display device, and a network interface. The terminal executes a client application that captures audio information, transmits communication data and user inputs to the server, and presents presentation information received from the server via the display device and the audio output device.

A user interacts with the system by using the terminal to conduct communication with another party and by optionally activating an AI-assisted mode through a graphical user interface. The user may, for example, press a button on the terminal to request evaluation of a suspicious statement or to switch from human handling to automatic response processing. The server stores program instructions in the memory, and the processor executes the instructions to implement the following functional modules: a communication control module, a speech-to-text interface module, a conversation history manager, a natural language processing module, a prompt generation module, a generative AI interface module, an emotion analysis module, a risk and urgency computation module, a presentation generation module, and a prompt adaptation module.

The server uses the communication control module to receive communication streams from the terminal via a network protocol such as Hypertext Transfer Protocol Secure. The communication control module parses metadata such as session identifiers, timestamps, and speaker labels, and routes audio data and text data to appropriate downstream modules. The server uses the speech-to-text interface module to cooperate with a cloud-based speech recognition service. In one example, the server and the terminal both can interface with a speech recognition service of the type generally provided as a cloud speech-to-text application programming interface. The terminal captures audio frames from the microphone, encodes the frames in a linear pulse code modulation or compressed format, and transmits the frames to the speech-to-text interface module or directly to the external speech recognition service. The speech recognition service applies acoustic models and language models to convert the audio information into character information. The speech-to-text interface module receives the recognition results, including recognized text and confidence scores, and forwards the text to the conversation history manager.

The server uses the conversation history manager to store and manage converted character information as conversation history. The conversation history manager writes each utterance to a relational database operated by the database management system, for example an SQL-based engine. Each utterance is stored in a structured record including at least a session identifier, a speaker identifier, a timestamp, a text field containing the character information, and metadata such as a recognition confidence value and language code. The conversation history manager also maintains an in-memory buffer of recent utterances for use by the natural language processing module and the prompt generation module.

The server uses the natural language processing module to transform utterance content into structured information. The natural language processing module may incorporate libraries of the type generally known for tokenization, part-of-speech tagging, dependency parsing, and named entity recognition. The natural language processing module decomposes each utterance into tokens, assigns syntactic and semantic labels, detects entities such as persons, organizations, products, locations, and monetary amounts, and constructs intermediate data structures such as dependency trees or semantic role labels. The module then compresses these analyses into a compact structured representation, for example a record comprising fields denoting a subject phrase, a predicate phrase, objects, modifiers, numerical values, and recognized entities. This structured information is stored alongside the raw text in the database and made available to the prompt generation module.

The server uses the prompt generation module to generate prompt sentences that instruct a generative AI model to perform specific evaluation and response tasks. The prompt generation module receives as input the structured information, the raw utterance content to be evaluated, and optionally additional context from the conversation history and external reference sources. The prompt generation module applies rule-based templates and parameterized patterns to assemble evaluation instruction sentences. For example, when a particular utterance is selected as an evaluation target, the prompt generation module may create an evaluation instruction sentence of the following form:
“You are an assistant for fraud and reliability detection. Analyze the following statement and evaluate the probability that it is true. Use the provided reference data. Return a score from 0 to 1 and a short explanation.
Statement: ‘[evaluation target utterance content]’
Reference data: [structured information and external data].”

The prompt generation module then treats this evaluation instruction sentence as a prompt sentence and passes it to the generative AI interface module together with any context text and parameters such as maximum output length and temperature.

The server uses the generative AI interface module to communicate with a generative AI model executed either locally on the server or on an external inference service. In one embodiment, the generative AI model is a transformer-based neural network comprising multiple self-attention layers, feedforward layers, and layer normalization, organized as an encoder-decoder or decoder-only architecture. The model is trained on large-scale text corpora using a language modeling objective and fine-tuned on a curated dataset of fact-checking, reliability-scoring, and action-recommendation tasks.

The server uses the generative AI interface module to serialize the prompt sentence and any context into a sequence of tokens compatible with the generative AI model, to transmit the sequence over an application programming interface, and to receive the model's output. The generative AI model applies multi-head attention, positional encoding, and learned weight matrices to compute token probability distributions, and generates output sequences representing, for example, an evaluation result and an explanation. The evaluation result can be encoded as a numeric score embedded in the generated text or as a structured segment using a predefined textual pattern. The generative AI interface module parses the generated text to extract the falsity or reliability score and the explanation, normalizes the score to a predetermined range, and forwards the evaluation result to the risk and urgency computation module.

The server uses the emotion analysis module to estimate an emotional state of the user. The emotion analysis module can operate on audio features, text features, or both. For audio-based emotion detection, the module extracts acoustic features such as pitch contour, energy, spectral centroid, and speaking rate from the user's audio segments. These features are fed into a classifier network such as a recurrent neural network or a temporal convolutional network trained to output probabilities over emotion categories such as fear, anger, sadness, and calmness. For text-based emotion detection, the module encodes the user's text utterances using a pre-trained language model and applies a classification layer trained with a cross-entropy loss on labeled emotion datasets. The emotion analysis module outputs emotion information consisting of emotion category labels and associated confidence values and writes this emotion information to the database in association with the corresponding user utterances.

The server uses the risk and urgency computation module to combine the evaluation result and the emotion information into quantitative measures of degree of risk and degree of urgency. The risk and urgency computation module may implement a rule-based system or a learned model. In one example, the module applies thresholding and weighting rules: a high falsity score combined with high fear or anxiety weight raises the degree of risk to a “high” level and sets the degree of urgency to an “immediate action required” level. A medium falsity score with neutral or calm emotion may produce a “monitor” risk level and a lower urgency level. The risk and urgency computation module writes the resulting measures to the conversation context and triggers the presentation generation module when thresholds are exceeded.

The server uses the presentation generation module to construct presentation information for the terminal. The presentation generation module assembles warning information and action instruction information based on the risk and urgency measures, the evaluation result, and the emotion information. When the system detects a potentially fraudulent or unreliable statement, the presentation generation module may generate warning information such as:
“This statement may be false or misleading. Please proceed with caution.”

In addition, the presentation generation module can request further candidate actions from the generative AI model by generating an additional prompt sentence. For example, the presentation generation module may generate the following prompt sentence:
“You are an assistant helping users avoid fraud and make safe decisions.
Here is the situation:
   Statement: ‘This investment is 100% guaranteed and you must send money now.’
   Falsity score: 0.85 (high likelihood of false or misleading).
   User emotion: high anxiety.
Propose 2-3 concrete next actions for the user, in polite language, that reduce risk
and increase safety. Do not encourage sending money. Respond in short bullet points.”

The generative AI interface module passes this additional prompt sentence to the generative AI model, which generates candidate actions such as: “Do not send any money now,” “Contact your financial institution's fraud department,” and “Verify the offer with an independent advisor.” The presentation generation module converts these candidate actions into action instruction information and embeds them in the presentation information as selectable options.

The terminal uses its display device to present the presentation information to the user in a graphical format. The terminal may, for example, display a color-coded reliability bar, textual warnings, and a list of action buttons. The terminal uses its audio output device to voice key warnings through a text-to-speech engine. By presenting the results in near real time during an ongoing call, the terminal assists the user in avoiding fraudulent or harmful actions.

The server uses the prompt adaptation module to update wording of prompt sentences based on past evaluation results and action selection history. The prompt adaptation module logs, for each session, the prompt sentences that were generated, the evaluation results returned by the generative AI model, and the actions selected by the user. The prompt adaptation module evaluates performance metrics such as correlation between predicted falsity scores and actual incident outcomes or user feedback, as well as rates at which users follow recommended actions. The module then adjusts parts of the prompt templates, for example by modifying instruction phrases, specifying output formats more explicitly, or changing the level of detail requested. These adjustments are stored as updated template parameters in the memory and applied in subsequent sessions. By iteratively refining prompt sentences, the server improves the stability and accuracy of outputs from the generative AI model and reduces variance due to ambiguous instructions.

The above-described configuration yields several technical effects beyond mere automation of human judgment. The server integrates speech recognition, natural language processing, generative model inference, and emotion analysis into a coordinated pipeline that operates on structured data representations rather than unstructured text alone. Because the server generates task-specific prompt sentences using structured information and emotional context, the generative AI model receives inputs that are less noisy and more informative than raw text. This reduces the number of model calls needed to achieve a given accuracy, thereby decreasing computational load and network usage. The use of in-memory conversation context and compact structured representations reduces database access frequency and improves processing latency compared to naive approaches that repeatedly query large text logs.

Furthermore, the server's risk and urgency computation module allows the system to prioritize high-risk situations with elevated urgency, enabling the application to allocate processing resources adaptively. For example, high-risk calls can be processed with higher-capacity generative models and more detailed prompts, while low-risk situations can be handled by smaller models or cached responses. This selective allocation improves computational efficiency and reduces average response time in a multi-session environment. The explicit prompt adaptation module also represents a technical improvement. Traditional systems treat prompts as static, hand-written text, causing model outputs to remain sensitive to small ambiguities. In contrast, the server continuously analyzes historical performance and user behavior to automatically refine the wording of evaluation instruction sentences and additional prompt sentences. This feedback-driven adaptation leads to more calibrated outputs from the generative AI model over time, reducing the need for manual reconfiguration and achieving lower error rates in falsity assessment. Because the adaptation operates directly on the textual input to the model, it can be applied without retraining the generative AI model itself, thereby reducing retraining cost and downtime.

From a machine learning perspective, the generative AI model and emotion analysis model can be trained using supervised learning. The server or an associated training system optimizes model parameters by minimizing loss functions such as cross-entropy loss between predicted and target tokens for language modeling, or between predicted and labeled emotions for emotion classification. Weight updates can be performed using gradient-based optimization methods such as stochastic gradient descent with momentum or adaptive methods. The system may also apply data augmentation techniques such as noise injection in audio, paraphrasing of text, and synthetic generation of borderline examples to improve robustness. These training methods produce models whose internal representations are tuned to capture patterns of deceptive statements, typical fraud language, and emotional cues indicating distress, thereby enabling the deployed inference pipeline to achieve higher detection accuracy and lower false positives than rule-based systems.

In another embodiment, the server executes the generative AI model locally on a hardware accelerator. The server loads the model weights into memory of a graphics processing unit and uses a parallel computation library to accelerate matrix multiplications and attention operations. By exploiting parallel hardware, the server significantly reduces the time required to generate evaluation results and candidate actions, allowing the system to respond within human conversational turn-taking intervals. This low latency makes the system suitable for real-time interactive use, such as during a live voice call.

In a further embodiment, the terminal implements additional logic to pre-filter audio segments based on voice activity detection and to compress less relevant parts of the conversation before transmission. By reducing the amount of data that the server must process, this configuration decreases network load and server-side processing overhead. The server's modules remain unchanged, demonstrating that the core architecture is compatible with different terminal-side optimizations.

In yet another embodiment, the server customizes the risk and urgency computation module for different application domains, such as financial transactions, medical consultations, or technical support calls. While the domain-specific thresholds and action catalogs may vary, the underlying pipeline—structured representation of utterance content, prompt sentence generation, generative AI inference, emotion analysis, and adaptive prompt refinement—remains constant. This modularity permits straightforward extension of the system to new domains without fundamentally altering the processing architecture.

Through these embodiments, the server, the terminal, and the user cooperate in a technically specific interaction: the terminal captures and presents multi-modal information, the server orchestrates complex data transformations and machine learning models using structured pipelines and adaptive prompts, and the user receives dynamically optimized warnings and action recommendations. The described architecture improves the functioning of the computer system itself by enhancing data management, reducing computational and communication overhead, and increasing the reliability and stability of model-based evaluations, thereby satisfying requirements for a concrete technical implementation.

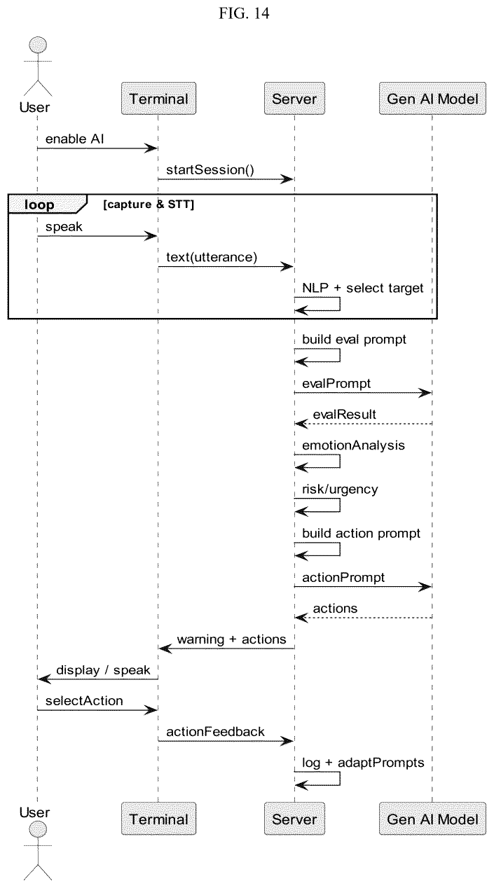

The following describes the processing flow using FIG. 14.

### Step 1:

User activates AI-assisted mode on the terminal.

User operates the terminal to enable assistance for a current or upcoming communication.
Input: User touch or click event on a graphical user interface element (for example, an “AI assist” button).
Output: A control signal indicating activation of AI-assisted mode, and a session start request sent to the server.

Terminal detects the user interaction, updates an internal session state to “AI active,” associates a new session identifier with the communication, and transmits a session initialization message to the server over a secure channel. Terminal embeds metadata such as user identifier, device identifier, timestamp, and communication type in the message.

### Step 2:

Terminal captures audio information from the communication.

Terminal acquires real-time voice signals from the user and/or a counterparty during a call or voice communication.
Input: Analog audio from a microphone or digital audio stream from a telephony subsystem.
Output: Encoded audio frames grouped into time-stamped chunks.

Terminal samples the analog signal at a predetermined sampling rate, for example 16 kHz, converts the samples into digital form, and segments the stream into fixed-length frames (for example, 20-30 ms). Terminal aggregates frames into audio chunks (for example, 0.5-1.0 seconds), encodes the chunks in a selected codec format, and attaches session and speaker identifiers to each chunk as metadata.

### Step 3:

Terminal performs speech recognition or forwards audio to a speech recognition service.

Terminal converts captured audio into character information suitable for text analysis.
Input: Encoded audio chunks with associated metadata.
Output: Character information (recognized text) with recognition confidence scores and timestamps.

Terminal either calls a remote speech recognition service or passes audio to a local client of such a service. Terminal streams the audio chunks, receives partial and final hypotheses for recognized text, and merges partial results into complete utterances based on end-of-speech detection. Terminal attaches recognition confidence values and time boundaries to each utterance and encapsulates the character information in a structured message.

### Step 4:

Terminal transmits recognized text to the server.

Terminal sends each recognized utterance to the server for further analysis and storage.
Input: Character information representing utterances, with session identifier, speaker label, timestamps, and confidence scores.
Output: Network request messages containing structured utterance data delivered to the server.

Terminal serializes the recognized text and metadata into a request payload and sends the payload to a designated application programming interface endpoint on the server using a secure transport protocol. Terminal may batch multiple utterances to reduce overhead while preserving order by including sequence indices.

### Step 5:

Server receives and stores conversation history.

Server records incoming utterances in a persistent data store to maintain conversation history.
Input: Structured utterance data packets from the terminal, each including text, session identifier, speaker label, timestamps, and confidence information.
Output: Database records representing conversation entries and an updated in-memory conversation context.

Server validates the payload, checks the session identifier, and inserts a new record into a conversation table in a database management system. Server writes fields such as session identifier, speaker identifier, time range, recognized text, confidence value, and language code. Server also appends the utterance to an in-memory list of recent utterances for the corresponding session to support low-latency processing.

### Step 6:

Server performs natural language processing on utterances.

Server analyzes the textual content of each utterance to derive structured information.
Input: Raw text of an utterance, together with session context and metadata from the conversation history.
Output: Structured information describing linguistic and semantic properties of the utterance.

Server tokenizes the text into words or subword units, assigns part-of-speech tags, and computes a dependency parse. Server then identifies named entities such as products, organizations, locations, and monetary amounts, and detects sentence type (for example, assertion, question, command). Server aggregates this analysis into a structured object including keys for subject, predicate, objects, modifiers, entities, and numerical values. Server stores this structured information in association with the original utterance in the database and exposes it to downstream modules.

### Step 7:

Server selects an evaluation target utterance.

Server determines which utterance in the conversation requires falsity or reliability evaluation.
Input: Conversation history containing multiple utterances and their structured information, plus optional triggers such as user requests or predefined rules.
Output: An evaluation target record specifying a particular utterance, its structured information, and related context utterances.

Server applies selection criteria, such as detection of claims with quantifiers (“best,” “100%,” “guaranteed”) or explicit user commands (for example, “check this statement”), to choose an utterance as an evaluation target. Server then retrieves the structured information and surrounding context utterances from the database and assembles them into an evaluation target record for the prompt generation module.

### Step 8:

Server generates a first prompt sentence for falsity or reliability evaluation.

Server constructs an instruction text for the generative AI model that describes the evaluation task and provides necessary context.
Input: Evaluation target record, including target utterance, structured information, and context utterances, and optionally external reference data such as product information or historical records.
Output: A first prompt sentence that encodes an evaluation instruction for the generative AI model.

Server applies a template-based algorithm, filling in fields of a predefined prompt pattern with the target utterance and structured information. For example, server composes a prompt sentence of the following form:
“You are an assistant for fraud and reliability detection. Analyze the following statement and evaluate the probability that it is true. Use the provided reference data. Return a score from 0 to 1 and a short explanation.
Statement: ‘[evaluation target utterance]’
Reference data: [summary of relevant facts and structured information].”

Server concatenates the header instructions, the statement, and the reference data into a single prompt string, ensuring that separators and labels are consistent so that the generative AI model can parse the task specification.

### Step 9:

Server inputs the first prompt sentence to the generative AI model and obtains an evaluation result.

Server requests the generative AI model to perform a falsity or reliability assessment.
Input: First prompt sentence together with model configuration parameters such as maximum token limit, temperature, and top-k or top-p sampling settings.
Output: Evaluation result including at least a falsity or reliability score and a natural-language explanation.

Server encodes the prompt sentence into tokens using the tokenization scheme of the generative AI model, constructs an inference request, and transmits the tokens to a generative model engine. The generative AI model processes the token sequence through its transformer layers, computing attention-based contextual representations and predicting output tokens iteratively. The resulting output string includes a numeric score and accompanying explanation text. Server parses the output to extract the score, converts the score into a normalized numerical value (for example, within 0-100), and stores the evaluation result linked to the evaluation target.

### Step 10:

Server performs emotion analysis for the user.

Server estimates the emotional state of the user based on audio and/or text data.
Input: User-originated utterances and associated audio segments or text segments from the conversation history.
Output: Emotion information consisting of emotion category labels and confidence measures.

Server extracts acoustic features such as pitch, energy, and speaking rate from audio segments or embeddings from a language model for text segments. Server feeds these features into an emotion classifier trained to output probabilities for predefined emotion categories. Server selects the category with the highest probability as the primary emotion, optionally retaining the full distribution, and writes this emotion information to a record associated with the corresponding time segment of the conversation.

### Step 11:

Server computes degree of risk and degree of urgency.

Server combines the evaluation result and emotion information to produce quantitative decision support metrics.
Input: Falsity or reliability score from the generative AI model and emotion information for the user during the relevant time window.
Output: Degree of risk and degree of urgency values or labels.

Server applies a function mapping the falsity score and emotion probabilities to risk and urgency levels, for example using thresholds and weights: a high falsity score with high fear probability yields a “high” risk and “urgent” status, while a moderate falsity score with neutral emotion yields a “medium” risk and “non-urgent” status. Server can implement this mapping as a lookup table or a small predictive model, and stores the computed levels along with the evaluation result.

### Step 12:

Server generates an additional prompt sentence for candidate actions.

Server prepares a second instruction text for the generative AI model, requesting specific recommended actions.
Input: Evaluation result including the falsity or reliability score and explanation, emotion information, and computed degree of risk and urgency.
Output: An additional prompt sentence describing the situation and requesting candidate actions.

Server formats a description of the situation, including the evaluated statement, its falsity score, and the user's emotional state, and inserts this description into an action-generation template. For example, server constructs a prompt sentence of the following form:
“You are an assistant helping users avoid fraud and make safe decisions.
Here is the situation:
   Statement: ‘[evaluation target utterance]’
   Falsity score: [numeric value and qualitative label]
   User emotion: [dominant emotion and intensity]
Propose 2-3 concrete next actions for the user, in polite language, that reduce risk and increase safety. Do not encourage sending money. Respond in short bullet points.”
   Server then passes this additional prompt sentence to the generative AI interface module for inference.

### Step 13:

Server obtains candidate action information from the generative AI model.

Server receives suggested actions generated in response to the additional prompt sentence.
Input: Additional prompt sentence and generative model parameters for controlled output (for example, limiting length and style).
Output: Candidate action information composed of one or more textual action descriptions.

Server submits the additional prompt as input to the generative AI model, which processes the prompt and emits suggested actions as text. Server parses the output into a list of distinct actions, assigns identifiers and optional priority scores, and ensures conformance with system policies by applying filters or rule checks (for example, rejecting actions that contradict safety requirements). Server stores the candidate action information for inclusion in presentation information.

### Step 14:

Server constructs presentation information for the terminal.

Server aggregates evaluation results, emotion information, and candidate actions into a coherent output package.
Input: Falsity or reliability score, explanatory text from the generative AI model, risk and urgency levels, and candidate action information.
Output: Presentation information message containing warning text, reliability indicators, and recommended actions formatted for user display.

Server generates a warning message appropriate to the risk level, such as a brief alert for low risk or a strong warning for high risk. Server also encodes reliability metrics (for example, as percentage values or textual labels) and assembles the candidate actions as a list. Server packages these elements into a structured message with layout hints such as severity level, color coding, or grouping of items, and prepares the message for transmission to the terminal.

### Step 15:

Server transmits presentation information to the terminal.

Server delivers the constructed response so that the terminal can present it to the user.
Input: Presentation information message ready for transmission.
Output: Network response packet delivered to the terminal, containing all elements necessary for user notification.

Server uses its communication control module to send the presentation information to the terminal via the established secure connection. Server may compress the payload or use incremental updates if multiple messages are sent over time.

### Step 16:

Terminal presents warnings and recommended actions to the user.

Terminal visualizes and optionally vocalizes the presentation information.
Input: Presentation information including warning text, reliability indicators, and candidate actions.
Output: Visual and auditory outputs on the terminal's display device and audio output device.

Terminal maps severity levels to display styles, for example coloring a status bar green, yellow, or red depending on risk. Terminal renders the reliability score as a numeric label or progress bar and shows candidate actions as interactive buttons or list items. Terminal may convert key warning text into speech using a text-to-speech engine and play the speech through a speaker or headset.

### Step 17:

User selects an action or continues the communication.

User responds to the presented information by choosing a recommended action or ignoring the suggestions.
Input: Visual or auditory presentation of warning and action options from the terminal.
Output: User interaction data indicating selected action or no selection.

User may select an action such as “end call,” “contact a trusted person,” or “request more information” by pressing a corresponding button on the terminal. Alternatively, user may continue the conversation without explicitly selecting an action. Terminal captures the user selection (if any) and packages it as feedback to the server along with a reference to the associated candidate action information.

### Step 18:

Server logs user behavior and updates prompt generation strategy.

Server records user choices and uses them to adapt future prompt sentences.
Input: User interaction data specifying which candidate actions were selected, rejected, or ignored, as well as evaluation results and conversation context.
Output: Updated prompt template parameters and performance statistics used in subsequent sessions.

Server stores action selection history in a dedicated table, correlating each prompt sentence and candidate action list with actual user behavior. Server computes performance metrics such as acceptance rate for recommended actions under various conditions and correlation between falsity scores and subsequent incident reports or user feedback. Based on these metrics, server modifies template text fragments in the first prompt sentence and the additional prompt sentence, for example by adding more explicit instructions, tightening score formatting instructions, or altering the framing of risk. These modifications adjust how input data is transformed into prompt sentences, with the aim of improving accuracy and stability of generative AI model outputs in future processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

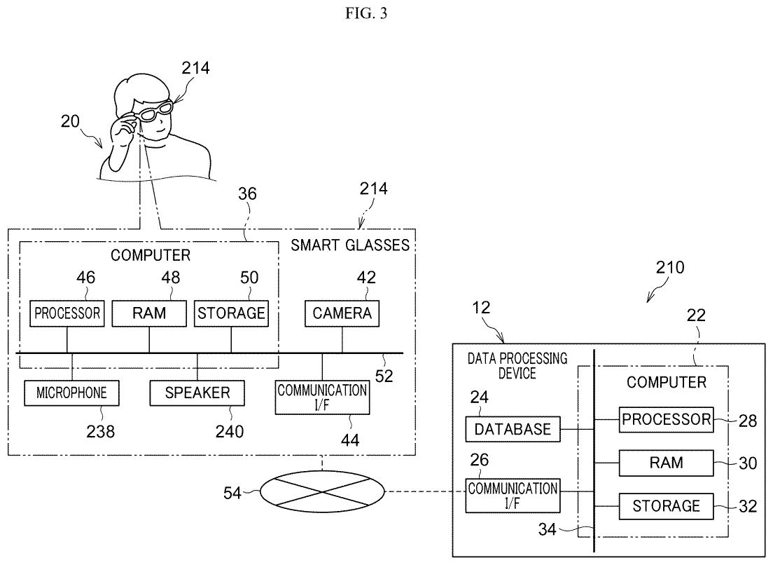

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

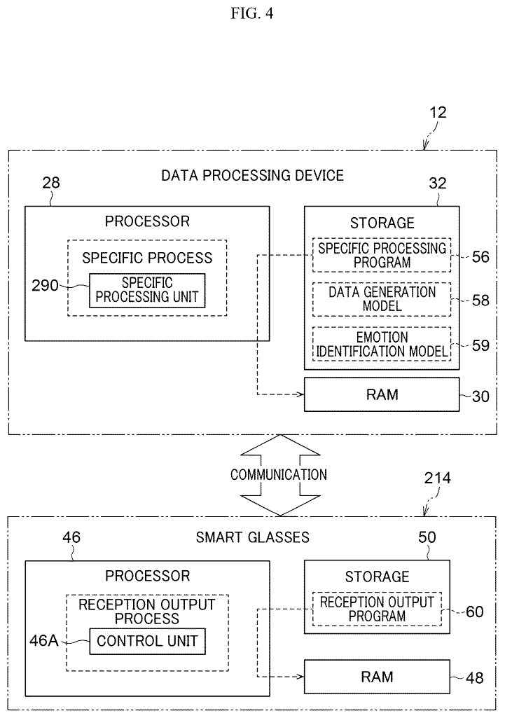

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

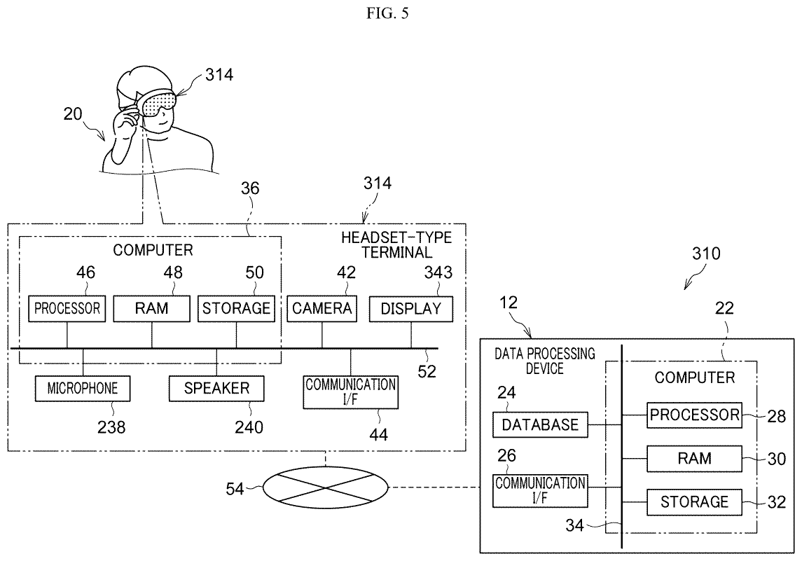

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

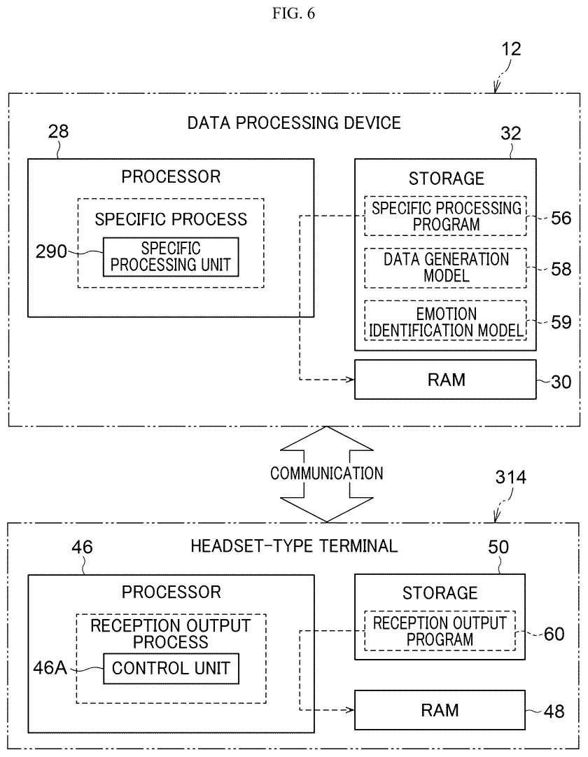

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

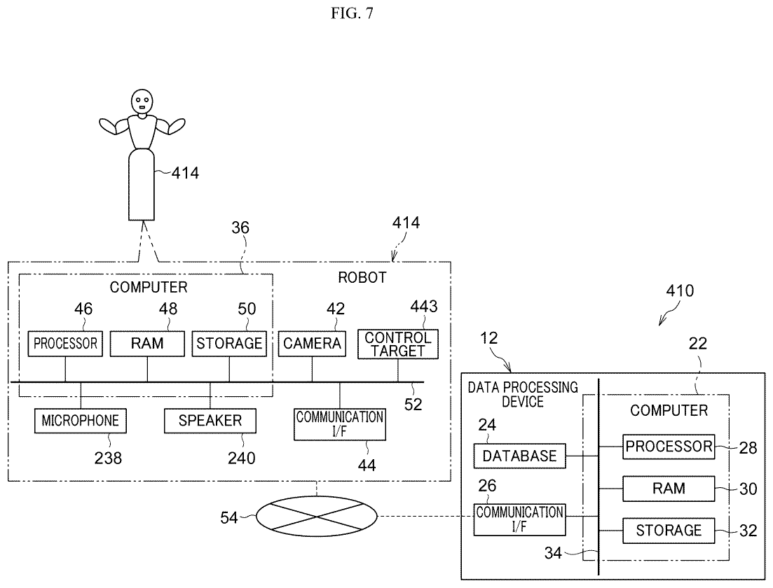

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

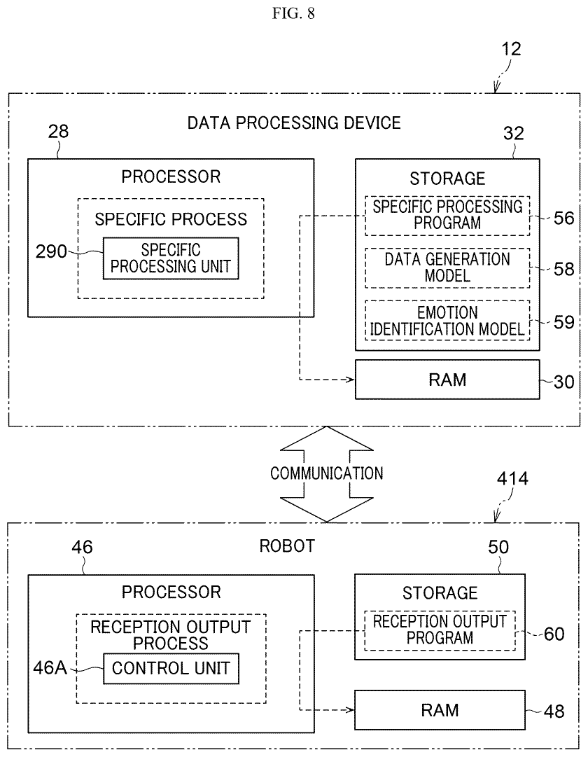

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

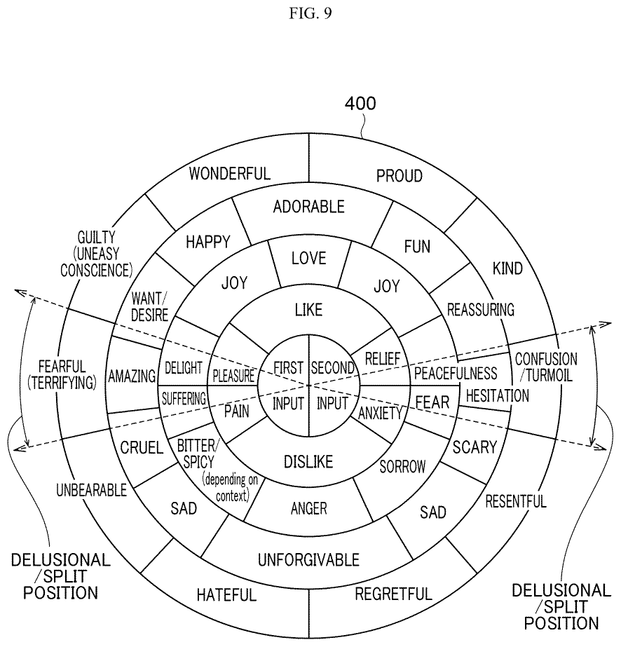

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

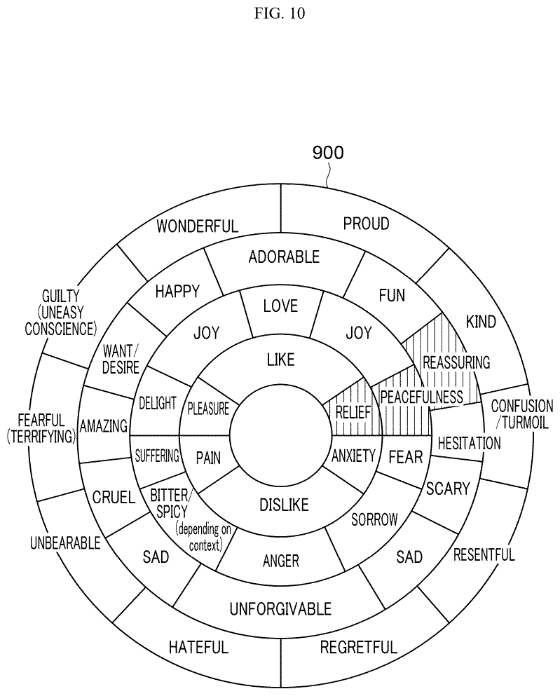

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
control switching of response to received communication from a human responder to an artificial intelligence automatic responder, based on operation information transmitted from a communication terminal, and
transmit audio information acquired from a communication infrastructure to a speech recognition processing unit to convert the audio information into character information, and sequentially store the character information and dialog history information in a recording information storage unit, and
generate an analysis request prompt sentence for evaluating a reliability level of utterance content, based on the character information and the dialog history information stored in the recording information storage unit, and input the prompt sentence and the character information to a natural language processing engine and a generative artificial intelligence model to acquire reliability evaluation information, and
generate a prompt sentence for generating next action candidates to be presented to a user, based on the reliability evaluation information and the dialog history information, and input the prompt sentence to the generative artificial intelligence model to acquire action candidate information, and
transmit the action candidate information and the reliability evaluation information to the communication terminal, and execute control processing corresponding to an action selected by the user at the communication terminal.

### Supplementary 2

The system according to supplementary 1,
wherein the processor is configured to
generate a prompt sentence for summarizing dialog content, based on the reliability evaluation information and the dialog history information, input the prompt sentence to the generative artificial intelligence model to acquire summary information, and transmit the summary information to the communication terminal.

### Supplementary 3

The system according to supplementary 1,
wherein the processor is configured to
calculate emotion state information for the character information using an emotion analysis engine, and generate a prompt sentence for adjusting the action candidate information based on the emotion state information and the reliability evaluation information, and input the prompt sentence to the generative artificial intelligence model to acquire adjusted action candidate information.

### Application Example 1

### Supplementary 1

A system comprising a processor,
wherein the processor is configured to
switch an incoming communication from a human response to an artificial intelligence automatic response,
acquire audio information corresponding to the incoming communication and convert the audio information into text information by using speech recognition processing,
generate a prompt sentence for evaluating falsity or suspiciousness of utterance content of a communication counterpart by using natural language processing on the text information and supplementary information relating to the incoming communication,
input the prompt sentence and the text information to a generative information processing model and cause the generative information processing model to generate response information to be transmitted to the communication counterpart,
transmit the response information obtained from the generative information processing model to the communication counterpart as an audio output or a character output in accordance with a medium of the incoming communication,
store conversation content of the communication as recording information in association with time-series information and speaker identification information,
apply the generative information processing model or a classification model to the recording information and calculate evaluation information indicating the falsity or the suspiciousness of the utterance content,
generate a prompt sentence for proposing a next action based on the evaluation information to be input to the generative information processing model,
input the prompt sentence for proposing the next action and the evaluation information to the generative information processing model and cause the generative information processing model to generate action proposal information to be presented to a user,
notify the action proposal information to a user terminal and cause the user terminal to perform display or audio guidance, and
generate an automatic response prompt sentence for a suspicious communication based on pre-stored response guideline information and the evaluation information, input the automatic response prompt sentence to the generative information processing model to cause the generative information processing model to generate automatic response information, and transmit the automatic response information to the communication counterpart.

### Supplementary 2

The system according to supplementary 1,
wherein the processor is configured to
generate, based on the evaluation information and the conversation content, a prompt sentence for generating explanation information including identification of which portions of the utterance of the communication counterpart are false or suspicious, and notify the explanation information to the user terminal.

### Supplementary 3

The system according to supplementary 1,
wherein the processor is configured to
adjust a style, a tone, and a level of detail of an action proposal prompt sentence or an automatic response prompt sentence to be input to the generative information processing model, based on emotion state information obtained by an emotion analysis processing of a user and the evaluation information.

### Example 2

### Supplementary 1

A system comprising a processor,
wherein the processor is configured to
switch handling of received communication from a human response to an automatic response process,
acquire audio information from an acoustic input unit of a terminal as digital audio information,
convert the digital audio information into character information by using a speech recognition technique,
acquire factual information from an external information source on the basis of the character information and time information or location information included in the character information,
apply a natural language processing technique to the character information to extract syntactic information and semantic information,
generate input information to be input to a generative information processing model by generating a prompt sentence including an evaluation instruction sentence for evaluating falsity of a statement on the basis of the character information, the factual information, and at least one of the syntactic information and the semantic information,
determine the falsity of the statement on the basis of analysis information output from the generative information processing model,
record the character information, the factual information, and a determination result of the falsity in association with each other in a storage device, and
transmit the determination result of the falsity to the terminal and output the determination result as display information.

### Supplementary 2

The system according to supplementary 1,
wherein the processor is configured to
generate the input information to be input to the generative information processing model by generating a prompt sentence including an action proposal instruction sentence for presenting candidate actions to be next executed by a user on the basis of the determination result of the falsity and the factual information, and obtain response information relating to the candidate actions from the generative information processing model so as to generate action proposal information.

### Supplementary 3

The system according to supplementary 1,
wherein the processor is configured to
apply emotion analysis processing to the character information to generate emotion information indicating an emotional state of the user, and
generate a prompt sentence for adjusting contents of at least one of the evaluation instruction sentence and the action proposal instruction sentence on the basis of the emotion information and the determination result of the falsity.

### Application Example 2

### Supplementary 1

A system comprising a processor,
wherein the processor is configured to
   switch handling of received communication from a human operator to an automatic response process,
   acquire audio information and convert the audio information into character information by using a speech recognition process,
   store the converted character information and manage the character information as conversation history,
   convert utterance content included in the conversation history into structured information by using a natural language processing process,
   generate a prompt sentence for causing a generative information processing model to evaluate falsity or reliability of the utterance content, by generating an evaluation instruction sentence including the structured information and evaluation target utterance content, and input the prompt sentence to the generative information processing model to obtain an evaluation result relating to the falsity or the reliability,
   execute an emotion analysis process to estimate an emotional state of a user from an audio response or a character response of the user and obtain emotion information,
   determine a degree of risk and a degree of urgency based on the evaluation result and the emotion information, and generate presentation information including warning information or action instruction information, and
   transmit the presentation information to a terminal device so that the presentation information is presented to the user via a display device or an audio output device of the terminal device.

### Supplementary 2

The system according to supplementary 1,
wherein the processor is configured to
generate an additional prompt sentence for instructing the generative information processing model to generate candidate actions to be executed, based on the evaluation result and the emotion information, input the additional prompt sentence to the generative information processing model to obtain candidate action information for proposing a next action including at least one of refusal of payment, inquiry to a third party, notification to a supervisory organization, and notification to a trusted contact, and transmit the candidate action information to the terminal device as part of the presentation information.

### Supplementary 3

The system according to supplementary 1,
wherein the processor is configured to
update wording of the evaluation instruction sentence and the additional prompt sentence based on past evaluation results obtained from the generative information processing model and on an action selection history by the user, thereby adaptively changing a prompt sentence generation process so that accuracy of falsity evaluation and suitability of action proposal are improved.

What is claimed is:

1. A system comprising:
circuitry configured to:
receive, via a communication interface coupled to a packet-switched network, audio stream data associated with a communication session from a terminal device, and switch a handling mode of the communication session from a manual response mode to an automated response mode;
convert the audio stream data into text data by executing a speech recognition pipeline comprising an acoustic model and a language model;
execute a natural language processing operation on the text data to extract linguistic feature vectors, and input the linguistic feature vectors into a neural network configured to output a reliability score indicating a confidence level that statements within the text data are consistent and truthful;
construct an instruction sequence comprising the text data, the reliability score, and a context parameter, and input the instruction sequence into a generative neural network model comprising a transformer-based architecture to generate response action data identifying a recommended action category; and
transmit the response action data to the terminal device via the communication interface.

2. The system according to claim 1, wherein the circuitry is further configured to:
segment the audio stream data into utterance segments based on speaker diarization, associate each utterance segment with a speaker identifier and a timestamp, and convert each utterance segment independently into text data.

3. The system according to claim 2, wherein the speech recognition pipeline further comprises:
a deep neural network acoustic model configured to receive spectrogram representations of the utterance segments and output phoneme probability sequences, and a language model configured to decode the phoneme probability sequences into text tokens with associated confidence scores.

4. The system according to claim 3, wherein the circuitry is further configured to:
extract from the text data a plurality of linguistic features comprising named entity identifiers, semantic relation indicators, and statement consistency metrics by comparing assertions within the text data against prior utterance segments within the communication session.

5. The system according to claim 4, wherein the neural network configured to output the reliability score comprises:
an input layer receiving the linguistic feature vectors and dialog history features, a plurality of hidden layers with nonlinear activation functions, and an output layer producing the reliability score as a probability value indicating a likelihood of deceptive content within the text data.

6. The system according to claim 1, wherein the circuitry is further configured to:
extract affective state features from the audio stream data by analyzing prosodic parameters comprising pitch variation, speech rate, and energy level, and input the affective state features into an emotion classification model configured to output an affective state vector over a plurality of affective state categories.

7. The system according to claim 6, wherein the circuitry is further configured to:
modify the instruction sequence to include the affective state vector, and instruct the generative neural network model to adjust the response action data based on the affective state vector such that the recommended action category accounts for a current affective state of the user.

8. The system according to claim 7, wherein the circuitry is further configured to:
increase a priority level of protective action categories in the response action data when the affective state vector indicates a high-intensity negative affective state, and decrease an urgency parameter of the response action data when the affective state vector indicates a neutral or positive affective state.

9. The system according to claim 1, wherein the circuitry is further configured to:
maintain a dialog history data structure storing text data, reliability scores, and affective state features for each utterance segment within the communication session, and include a context window of recent entries from the dialog history data structure in the instruction sequence for each subsequent reliability score determination.

10. The system according to claim 9, wherein the circuitry is further configured to:
detect a change in the reliability score exceeding a threshold between consecutive utterance segments, and in response, generate an alert data record transmitted to the terminal device indicating a detected inconsistency pattern.

11. The system according to claim 1, wherein the generative neural network model comprises:
an embedding layer configured to convert tokens of the instruction sequence into embedding vectors, a positional encoding module, a plurality of transformer layers each comprising multi-head self-attention and feed-forward sublayers with layer normalization, and a decoding stage configured to generate a probability distribution over a vocabulary and select output tokens.

12. The system according to claim 11, wherein the circuitry is further configured to:
set inference parameters for the generative neural network model comprising a temperature value and a maximum token count, and configure the instruction sequence to include an output format specification instructing the generative neural network model to produce the response action data as structured data comprising an action category identifier, a confidence value, and a reasoning text segment.

13. The system according to claim 1, wherein the circuitry is further configured to:
parse the response action data to extract the recommended action category, retrieve from an information storage device a set of executable action procedures associated with the recommended action category, and transmit the executable action procedures to the terminal device for presentation to the user.

14. The system according to claim 13, wherein the circuitry is further configured to:
receive a user selection of one of the executable action procedures from the terminal device, and execute the selected action procedure by transmitting a control signal via the communication interface to modify a state of the communication session.

15. The system according to claim 1, wherein the circuitry is further configured to:
generate an automated voice response by inputting the response action data into a text-to-speech synthesis module, and transmit the automated voice response as audio data to a remote terminal associated with the communication session to continue the communication session in the automated response mode.

16. The system according to claim 1, wherein the circuitry is further configured to:
store the text data, reliability scores, and response action data for the communication session in an information storage device as a session record, and generate a summary report data by constructing a second instruction sequence comprising the session record and inputting the second instruction sequence into the generative neural network model.

17. The system according to claim 16, wherein the session record further comprises:
a classification label identifying the communication session as a potentially fraudulent call, a harassment call, or an unverified identity call, and the summary report data includes a recommendation to contact law enforcement authorities, to block the remote party, or to initiate an identity verification procedure.

18. A system comprising:
circuitry configured to:
receive audio stream data associated with a communication session from a terminal device via a communication interface and switch a handling mode from manual response to automated response;
convert the audio stream data into text data using a speech recognition pipeline, extract linguistic feature vectors via natural language processing, and compute a reliability score using a neural network indicating consistency and truthfulness of statements in the text data;
extract affective state features from the audio stream data, input the affective state features into an emotion classification model to determine an affective state vector, and construct an instruction sequence comprising the text data, the reliability score, and the affective state vector;
input the instruction sequence into a generative neural network model to generate response action data adjusted based on the affective state vector; and
transmit the response action data to the terminal device.

19. The system according to claim 18, wherein the circuitry is further configured to:
maintain a dialog history data structure for the communication session, detect changes in the reliability score between consecutive utterance segments, and generate alert data when a change exceeds a threshold value.

20. A method comprising:
receiving, by circuitry via a communication interface coupled to a packet-switched network, audio stream data associated with a communication session from a terminal device, and switching a handling mode of the communication session from a manual response mode to an automated response mode;
converting the audio stream data into text data by executing a speech recognition pipeline comprising an acoustic model and a language model;
executing a natural language processing operation on the text data to extract linguistic feature vectors, and inputting the linguistic feature vectors into a neural network configured to output a reliability score indicating a confidence level that statements within the text data are consistent and truthful;
constructing an instruction sequence comprising the text data, the reliability score, and a context parameter, and inputting the instruction sequence into a generative neural network model comprising a transformer-based architecture to generate response action data identifying a recommended action category; and
transmitting the response action data to the terminal device via the communication interface.
